(19) United States
(12) Patent Application Publication
(10) Pub. No.: US 2017/0076102 A1
(43) Pub. Date: Mar. 16, 2017

(54) SEMICONDUCTOR DEVICE

(71) Applicant: Renesas Electronics Corporation, Tokyo (JP)

(72) Inventors: Kuniyasu ISHIHARA, Tokyo (JP); Hiroshi UEKI, Tokyo (JP)

(21) Appl. No.: 15/214,095

(22) Filed: Jul. 19, 2016

(30) Foreign Application Priority Data
Sep. 15, 2015 (JP) 2015-182140

(51) Int. Cl. G06F 21/62; G06F 21/54; G06F 21/12; G06F 12/14

(52) U.S. Cl. CPC G06F 21/6209; G06F 12/1408; G06F 12/1441; G06F 21/54; G06F 21/12; G06F 2212/1052; G06F 2212/402; G06F 2221/032; G06F 2221/0797

(57) ABSTRACT

A semiconductor device capable of arbitrarily operating a microprocessor while protecting a secure program is provided. The semiconductor device includes a memory equipped with a first program area in which an arbitrary program is stored, and a second program area in which a secure program is stored, a microprocessor which outputs an address designating an instruction in a program, and a memory protection unit which controls access to the memory based on the address outputted from the microprocessor. When the address outputted from the microprocessor by executing the program in the first program area designates a branch allowable area in the second program area, the memory protection unit permits access to the memory. When the address designates a branch prohibition area, the memory protection unit inhibits access to the memory.

### CROSS-REFERENCE TO RELATED APPLICATIONS

The disclosure of Japanese Patent Application No. 2015-182140 filed on Sep. 15, 2015 including the specification, drawings and abstract is incorporated herein by reference in its entirety.

### BACKGROUND

The present invention relates to a semiconductor device, and particularly to a semiconductor device having a microprocessor and an electrically rewritable nonvolatile memory both built in a single semiconductor chip.

A semiconductor device including a microprocessor (hereinafter also called a central processing unit) and an electrically rewritable nonvolatile memory both built in a single semiconductor chip has been known as, for example, a microprocessor. Such a microprocessor has often been used even in a product field that require security. When the microcomputer is used in the product field requiring the security, an attack against the security is principally performed from the outside of the microcomputer. Therefore, in order to protect the security, the microcomputer is set to become high in terms of resistance to the attack from its outside, but is often weak in terms of resistance to the attack in the microcomputer.

The microprocessor built in the microcomputer is operated by, for example, a real time operating system (hereinafter also called RTOS), and an application program is operated on this RTOS. In this case, in order to protect the RTOS from the runaway of the application program, an attempt is made to generate an exception interrupt and operate the RTOS in a privileged mode. Thus, even though the application program is caused to run away maliciously within the microcomputer, it is possible to protect the RTOS. A problem however arises in that the microcomputer is weak against such an attack as to repeatedly give power supply noise or the like.

As a technology related to the protection of a computer system, there has been a technology described in, for example, Patent Document 1.

### RELATED ART DOCUMENTS

### Patent Document

[Patent Document 1] Japanese Unexamined Patent Publication Laid-Open No. 2007-304954

### SUMMARY

The present inventors have thought a new business model of selling a semiconductor device. While the new semiconductor device business sales model will be described in detail later, the summary of the new semiconductor device business sales model will be described herein to explain problems to be solved.

In the new semiconductor device business sales model, a program (hereinafter also referred to as a secure program) whose security should be ensured, like an RTOS is stored in a nonvolatile memory of a microcomputer in advance and sold. That is, the secure program is provided to a user who uses a semiconductor device like a microcomputer. The user having purchased the microcomputer generates, for example, a user program operated on the RTOS and stores same in the nonvolatile memory. In this case, since the user may generate a user program using a function provided in the RTOS, it becomes easy therefor to generate the user program. As a result, the user is capable of easily manufacturing a microcomputer (semiconductor device) having a function that the user desires.

In this case, a person (hereinafter also called a “provider”) who sells (provides) a microcomputer sells same with, for example, the addition of a value for the program like the RTOS to a value for the microcomputer having built therein the nonvolatile memory free of the storage of the program like the RTOS being taken as a sales price. Consequently, the provider is capable of increasing profits, and the user can use a microprocessor easy to generate a user program. It becomes possible to easily obtain a microcomputer having a desired function. That is, merits are generated to both of the provider and the user.

In the semiconductor device business sales model, the user generates a program operated on the RTOS. That is, the user generates a program adapted to manipulate the microprocessor built in the microcomputer. Therefore, the microcomputer is required to enable arbitrary invoking of the function included in the RTOS from the user's program.

Here, since the user is able to generate the program adapted to arbitrarily manipulate the microprocessor and to arbitrarily access even to the function of the RTOS, new problems arise. It is feared that, for example, the user is also able to generate such a user program as to copy the RTOS, i.e., a hacking program. When the RTOS is copied with malicious intent, it is also made possible to, for example, purchase an inexpensive microcomputer and store the copied RTOS in the microcomputer. This will lead to the fact that merits for the provider are lost.

There has been described in Patent Document 1, a technology related to a computer system capable of preventing deletion, falsification, leakage, etc. with respect to confidential data in a storage area due to a buffer overflow attack or the like. That is, a computer system (1) shown in FIG. 1 of Patent Document 1 is equipped with a memory map circuit (15) which stores therein an access control memory map to which the presence/absence of an access right for program execution from a CPU (10) for each address in a storage area (19) is set, and an access right determination circuit (16). The access right determination circuit (16) determines the presence/absence of the access right from the CPU (10) to the storage area for an execution program storage address (Spc) designated by a program counter (20), based on the access control memory map. In the absence of the access right, the access right determination circuit (16) outputs an access inhibition signal (SC) which causes the CPU (10) to execute predetermined processing which disables access from the CPU (10) to the storage area for the execution program storage address.

Thus, it is possible to protect the computer system against an attack causing the CPU to run away by making an attack from the outside of the computer system (1), e.g., power supply noise.

This however relates to a technology for the attack from the outside of the computer system and is not intended for an attack where the CPU as the microprocessor can arbitrarily be operated. It is needless to say that the new semiconductor business sales model is not described either.

A semiconductor device according to one aspect of the present invention includes a memory including a first program area in which an arbitrary program is stored, and a second program area in which a program whose security is to be ensured is stored, a central processing unit (microprocessor) which outputs an address designating an instruction in a program, and a memory protection unit which controls access to the memory based on the address outputted from the central processing unit. When an address outputted from the central processing unit by executing the program in the first program area designates a first area in the second program area, the memory protection unit permits access to the memory by the central processing unit. When the address designates a second area different from the first area, the memory protection unit inhibits access to the memory by the central processing unit.

That is, when the arbitrary program in the first program area accesses the first area in the second program area storing therein the program whose security should be ensured, its access is permitted. When the second area in the second program area is accessed, its access is inhibited. Consequently, it is made possible to use the program whose security should be ensured, from the arbitrary program and protect the program whose security should be ensured.

Also, a semiconductor device according to another aspect of the present invention includes an electrically rewritable nonvolatile memory which stores therein a program whose security is to be ensured, a central processing unit which outputs an address designating an instruction to be executed, and a memory protection unit which detects whether the address outputted from the central processing unit designates a secure program area in which the program is stored within the nonvolatile memory. Further, the semiconductor device includes a nonvolatile memory rewrite control circuit which controls rewriting of the nonvolatile memory, and an illegal access detection circuit. Here, the illegal access detection circuit causes the nonvolatile memory rewrite control circuit to inhibit the rewriting when the memory protection unit detects that the address outputted from the central processing unit does not designate the inside of the secure program area.

Thus, when the central processing unit does not execute the program in the secure program area, the rewriting of the electrically rewritable nonvolatile memory is inhibited. In other words, when a program is executed in a non-secure program area in which a user program is executed, the rewriting of the electrically rewritable nonvolatile memory is inhibited. As a result, it is made possible to rewrite the program whose security should be ensured. Further, it is possible to protect the program in the secure program area from the rewriting by the program in the non-secure program area.

Further, in a further aspect of the present invention, there is provided a semiconductor device in which a program whose security is to be ensured is encrypted and which is formed in a semiconductor chip. Here, the semiconductor device is equipped with an electrically rewritable nonvolatile memory, a central processing unit coupled to the nonvolatile memory and capable of executing a program written therein, a decryption circuit which decrypts the program provided with being encrypted, and a rewriting circuit which writes the program decrypted by the decryption circuit directly into the nonvolatile memory.

Thus, since the decrypted program is directly written into the nonvolatile memory even when it is made possible to arbitrarily operate the central processing unit by the user program, it is possible to protect the program.

According to one aspect of the present invention, it is possible to provide a semiconductor device capable of arbitrarily operating a central processing unit while protecting a secure program.

### BRIEF DESCRIPTION OF THE DRAWINGS

FIG. 1 is a system diagram showing the configuration of a semiconductor device business sales model according to an embodiment 1;

FIG. 2 is a block diagram showing the configuration of a microcomputer according to the embodiment 1;

FIG. 3 is a block diagram showing the configuration of a memory protection unit according to the embodiment 1;

FIG. 4 is an explanatory diagram for describing the protection of a memory;

FIG. 5 is a typical diagram of a secure program;

FIG. 6 is an explanatory diagram for describing the protection of the memory by the memory protection unit according to the embodiment 1;

FIGS. 7A and 7B are respectively a block diagram showing the configurations of a fetch start address monitoring circuit and a fetch address comparing circuit according to the embodiment 1, and an explanatory diagram sowing a secure program area;

FIGS. 8A through 8D are respectively timing diagrams showing the operation of the memory protection unit according to the embodiment 1;

FIGS. 9A through 9D are respectively timing diagrams showing the operation of the memory protection unit according to the embodiment 1;

FIG. 10 is a table showing the operation of the memory protection unit according to the embodiment 1;

FIG. 11 is an explanatory diagram for describing the protection of a memory by a memory protection unit according to a modification of the embodiment 1;

FIG. 12 is a layout diagram showing the layout of data stored in a flash memory according to an embodiment 2;

FIG. 13 is a block diagram showing the configuration of a microcomputer according to the embodiment 2;

FIG. 14 is a block diagram showing the configuration of an illegal access detection circuit according to the embodiment 2;

FIG. 15 is a block diagram showing the configuration of a microcomputer according to an embodiment 3;

FIG. 16 is a block diagram showing the configuration of a microprocessor according to an embodiment 4;

FIG. 17 is a flowchart diagram showing the operation of a microprocessor;

FIG. 18 is a flowchart diagram showing the operation of the microprocessor according to the embodiment 4;

FIG. 19 is a block diagram showing another configuration of the microprocessor according to the embodiment 4; and

FIG. 20 is a flowchart diagram showing another operation of the microprocessor according to the embodiment 4.

### DETAILED DESCRIPTION

Embodiments of the present invention will hereinafter be described in detail on the basis of the accompanying drawings. Incidentally, the same reference numerals are respectively attached to the same parts in principle in all the drawings for describing the embodiments, and a repeated description thereof will be omitted in principle.

### Embodiment 1

### Semiconductor Device Business Sales Model

While a plurality of embodiments will be described below, semiconductor devices to be described in the respective embodiments are respectively sold according to a new business sales model contemplated by the present inventors. A description will first be made here about a semiconductor device business sales model contemplated by the present inventors.

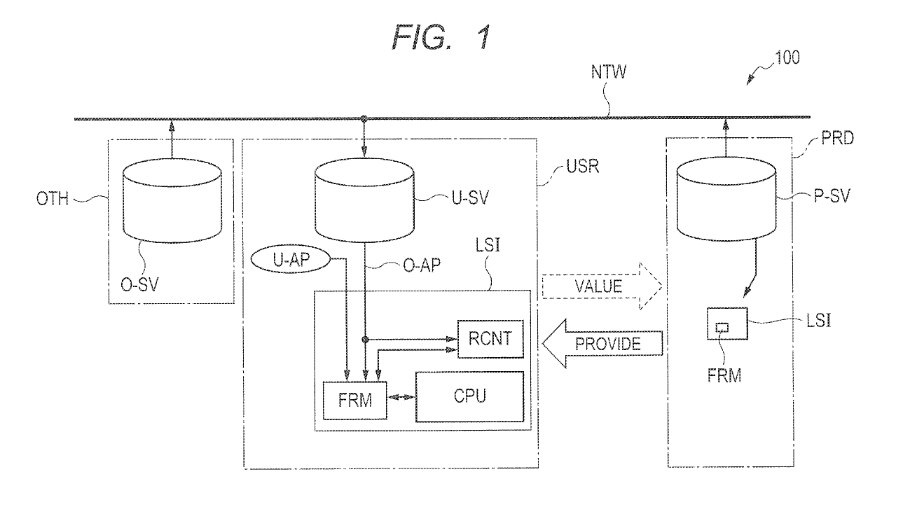

FIG. 1 is a system diagram showing the configuration of a semiconductor device business sales model according to the embodiment. In the same drawing, reference numeral 100 indicates the semiconductor device business sales model. Although not limited in particular, the semiconductor device business sales model 100 is comprised of a provider PRD, a user USR, and a third party OTH who provides a program.

The provider PRD sells a microcomputer LSI to the user USR. In the microcomputer LSI, a plurality of circuit blocks are formed into a single semiconductor chip by the known semiconductor manufacturing method. The circuit blocks formed in the semiconductor chip each include an electrically rewritable nonvolatile memory FRM, a microprocessor (hereinafter also called a central processing unit) CPU operated in accordance with a program written into the nonvolatile memory FRM, and a license management unit RCNT. The microcomputer LSI may be manufactured by the provider PRD. Alternatively, the microcomputer LSI may be produced by an unillustrated semiconductor manufacturing maker and sold by the provider PRD.

The provider PRD has a server P-SV in which many types of programs are stored. The programs stored in the server P-SV include a non-free program which requires the granting of a license when a program is executed, and a free program which requires no granting of the license upon executing it. Before the provider PRD sells the microcomputer LSI to the user USR, the provider PRD writes one or plural types of programs into the nonvolatile memory FRM in the microcomputer LSI. A program of an RTOS corresponding to the non-free program will be described here as being written into the nonvolatile memory FRM. When copying or the like is illegally performed on the program of the RTOS corresponding to the non-free program, a license fee is not recovered. Therefore, the program of the RTOS corresponds to a program whose security should be ensured, i.e., a secure program.

When the provider PRD sells the microcomputer LSI to the user USR, the provider PRD adds a license fee (license remuneration) required when granting the license of the RTOS corresponding to the non-free program to a value for the microcomputer LSI placed in a state in which no program is written into the nonvolatile memory FRM, and determines the value (sales price) of the microcomputer in which the program of the RTOS is written into the nonvolatile memory FRM. Incidentally, the sales price of the microcomputer in which the program of the RTOS is written into the nonvolatile memory FRM fluctuates for sales promotion or the like.

The user USR purchases the microcomputer LSI having the nonvolatile memory FRM with the program of the RTOS written therein in advance by paying a value including the license fees for the program of the RTOS as indicated by a broken line. Although not limited in particular, the user USR has a server U-SV. The server U-SV is coupled to a server P-SV of the provider PRD or/and a server O-SV of the third party OTH through, for example, a network NTW. The user USR downloads a non-free program or/and a free program from the server P-SV of the provider PRD or/and the server O-SV of the third party to the server U-SV through the network NTW and stores the same into the server U-SV. The user USR writes, for example, a user program U-AP generated by the user USR itself and a program O-AP stored in the server U-SV into the nonvolatile memory FRM of the purchased microcomputer LSI in such a manner that a desired function is achieved by the purchased microcomputer LSI.

In this case, the user program U-AP and the program O-AP from the server U-SV are generated so as to be operated on the program of the RTOS. For example, the user program U-AP and the program O-AP are generated such that a subroutine in the program of the RTOS is effectively used. The microprocessor CPU executes the program of the RTOS, the user program U-AP and the program O-AP stored in the nonvolatile memory FRM, so that a desired function from the user USR is realized by the microcomputer LSI.

When the user program U-AP is generated, the user generates it so as to utilize the program of the RTOS. Thus, it is possible to reduce a burden on the user USR when generating the user program U-AP.

In the present embodiment, although not restricted in particular, the microcomputer LSI is equipped with the license management unit RCNT. When the microcomputer LSI is sold to the user USR, the provider PRD writes license information equivalent to the number of licenses desired by the user USR into the nonvolatile memory FRM and sells it. The sales price of the microcomputer LSI in this case further includes license fees corresponding to the number of the licenses desired by the user USR.

When the user USR writes a program into the nonvolatile memory FRM, the license management unit RCNT determines whether the program to be written therein is a non-free program. When it is determined that the program to be written is of the non-free program, the license management unit RCNT refers to the license information stored in advance in the nonvolatile memory FRM and thereby determines whether the number of the licenses is one or more. If the number of the licenses is one or more, the license management unit RCNT writes a program into the nonvolatile memory FRM. If the number of the licenses is less than 1, the license management unit RCNT inhibits writing into the nonvolatile memory FRM. Further, when the program is written into the nonvolatile memory FRM, the license management unit RCNT updates the number of licenses represented by the license information stored in the nonvolatile memory FRM in such a manner that the number thereof is reduced by 1.

In the present embodiment, the license fee is prepaid when the microcomputer LSI is purchased. The user USR is capable of installing the non-free program in the nonvolatile memory FRM and executing it until the prepaid license fee is made insufficient. Thus, since the license fee is prepaid, the license fee can be prevented from being unrecovered, and the management of payment of the license fee also becomes easy.

Although there is shown here, the example in which the provider PRD writes the license information equivalent to the number of licenses desired by the user USR into the nonvolatile memory FRM before its selling, the present embodiment is not limited to this. For example, the provider PRD may provide a microcomputer LSI in which license information equivalent to the number of licenses determined in advance is written.

Although there is shown the semiconductor device business sales model where the microcomputer LSI is sold, the semiconductor device to be sold is not limited to the microcomputer LSI.

<Configuration of Microcomputer>

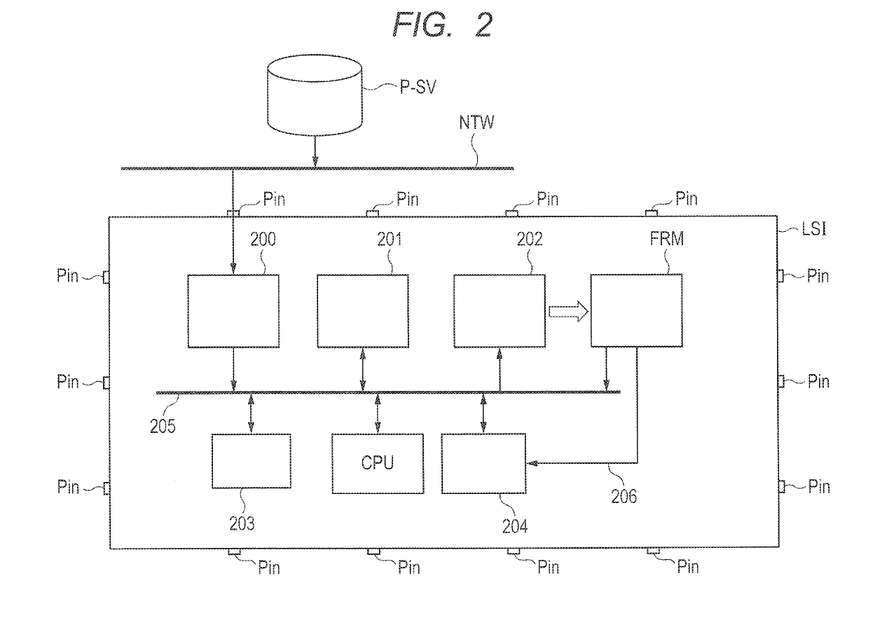

FIG. 2 is a block diagram showing the configuration of the microcomputer LSI according to the embodiment 1. As described in FIG. 1, the microcomputer LSI includes a plurality of circuit blocks formed into a single semiconductor chip by the known semiconductor manufacturing technology. Some of the circuit blocks described above are illustrated in FIG. 2. That is, only the circuit blocks required upon describing the present embodiment are shown. For example, the license management unit RCNT and the like described in FIG. 1 are omitted. Further, there is shown where in the microcomputer LSI shown in FIG. 2, a so-called flash memory is used as the electrically rewritable nonvolatile memory FRM. Incidentally, the same symbol FRM as the nonvolatile memory shown in FIG. 1 is attached to the flash memory.

The state of the microcomputer LSI sold from the provider PRD to the user USR is illustrated in FIG. 2. That is, the payment from the user USR to the provider PRD and the state of the microcomputer LSI purchased from the provider PRD are shown inclusive of the value for the program of the real time operating system (RTOS). Therefore, the microcomputer LSI is in a state in which the program of the RTOS is written and stored in the flash memory FRM. Further, FIG. 2 illustrates a state in which the microcomputer LSI is coupled to the server P-SV of the provider PRD through the network NTW to perform version upgrading of the program (e.g., program of RTOS) written in the flash memory FRM. Incidentally, the server U-SV of the user USR is omitted in FIG. 2 to avoid a complicated drawing.

In FIG. 2, reference numeral 200 indicates a communication functional circuit, reference numeral 201 indicates an encryption/decryption functional circuit, reference numeral 202 indicates a flash memory rewriting circuit, reference numeral 203 indicates a volatile memory, reference numeral 204 indicates a memory protection unit, reference numeral 205 indicates a bus, and reference numeral 206 indicates a signal wiring, respectively.

The communication functional circuit 200 performs transmission/reception of data between the outside and inside of the microcomputer LSI. For example, the communication functional circuit 200 receives an upgraded program (software) from the outside of the microcomputer LSI and stores the same therein. The encryption/decryption functional circuit 201 decrypts an encrypted program and converts it into an unencrypted program (decrypted program). The flash memory rewriting circuit 202 writes supplied data, e.g., a program into the flash memory FRM. The volatile memory 203 is comprised of, for example, a static memory or a dynamic memory and temporarily stores data like a program therein. While the memory protection unit 204 will be described in detail later, the memory protection unit 204 controls access from the microprocessor CPU to the memories (flash memory FRM and volatile memory 203) on the basis of information from the flash memory FRM and information from the microprocessor (central processing unit) CPU.

For example, in order to perform version upgrading of the program stored in the flash memory FRM, the microcomputer LSI is coupled to the network NTW, so that the upgraded program is downloaded into the microcomputer LSI. Upon this downloading, the program becomes a state easy to be stolen. A description will therefore be made below about the operation at this downloading.

The program has been encrypted. It is therefore not possible to execute the program even though it is stolen from the server P-SV. Likewise, when the program is downloaded, the program has been encrypted even at this time although it passes through the network NTW. It is therefore not possible to execute the program even though it is stolen.

When the program is supplied to the microcomputer LSI via the network NTW, the communication functional circuit 200 receives data corresponding to the program and stores the same therein. Next, the microprocessor CPU receives the data being the program from the communication functional circuit 200 through the bus 205 and transfers the same to the volatile memory 203 through the bus 205. Since the program stored in the volatile memory 203 has been encrypted, the microprocessor CPU next transfers the encrypted program stored in the volatile memory 203 to the encryption/decryption functional circuit 201 through the bus 205. The encryption/decryption functional circuit 201 releases encryption of the program and converts it into an unencrypted program. The microprocessor CPU transfers the unencrypted program to the volatile memory 203 through the bus 205.

Thereafter, the microprocessor CPU transfers the unencrypted program stored in the volatile memory 203 to the flash memory rewriting circuit 202 through the bus 205. The flash memory rewriting circuit 202 writes the supplied unencrypted program into the flash memory FRM. Thus, for example, the version-upgraded program is stored in the flash memory FRM. The microprocessor CPU reads and executes the version-upgraded program stored in the flash memory FRM.

As is understood from the description of the abovementioned operation, when the program is downloaded and written into the flash memory FRM, a period during which the unencrypted program exists occurs in the encryption/decryption functional circuit 201, the flash memory rewriting circuit 202, the volatile memory 203, and the microprocessor CPU. Further, the unencrypted program exists even in the flash memory FRM. Therefore, there is a need to protect against stealing of the unencrypted program during the period in which the unencrypted program exists. The unencrypted program which exists in the flash memory FRM is also required to be protected from being stolen.

In the present embodiment 1, attention is paid to the fact that only the microprocessor CPU has the function of accessing the memories such as the volatile memory 203, the flash memory FRM, etc. A limit to an area to which the microprocessor CPU can get access is provided by the memory protection unit 204. In this case, information which designates the area is directly transmitted from the flash memory FRM to the memory protection unit 204 by the signal wiring 206 without interposing the bus 205.

Incidentally, in FIG. 2, Pins respectively provided on the sides of the microprocessor LSI typically indicate external terminals (pins) of the microprocessor LSI.

<Configuration of Memory Protection Unit>

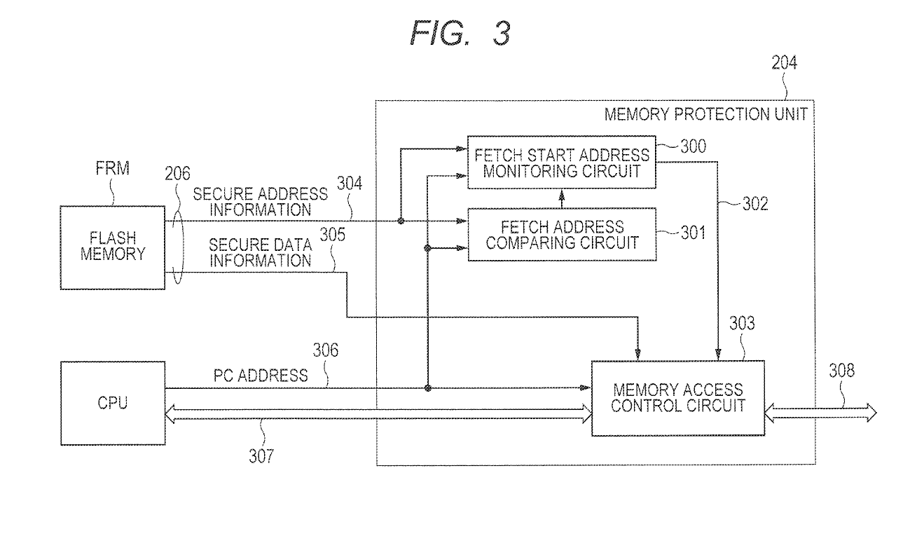

The configuration of the memory protection unit 204 will next be described using FIG. 3. FIG. 3 is a block diagram showing the configuration of the memory protection unit according to the embodiment 1. For convenience of description, the microprocessor CPU and the flash memory FRM are also illustrated in the same drawing.

The program is comprised of a plurality of instructions. The microprocessor CPU outputs an address designating the instruction to be executed from the instructions in the program. That is, the microprocessor CPU has a program counter. The address which designates the instruction to be executed is formed by the program counter. In FIG. 3, the address formed by the program counter, i.e., the address which designates the instruction to be executed is shown as a PC address 306. Further, data to be input/output to and from the microprocessor CPU is designated at reference numeral 307.

In the present embodiment 1, when the provider PRD writes a program whose security should be ensured into the flash memory (nonvolatile memory) FRM and performs selling of the microprocessor, the provider PRD writes secure address information 304 designating a program area of the flash memory FRM with the program (secure program) whose security should be ensured being stored therein into the flash memory FRM and performs selling thereof. Further, at this time, the provider PRD writes secure data information 305 designating a data area storing data (secure data) whose security should be ensured in the volatile memory 203 (FIG. 2) into the flash memory FRM.

Since the program of the RTOS is of the non-free program, it is a secure program. Therefore, the secure address information 304 for specifying the program area of the flash memory FRM with the program of the RTOS written therein, and the secure data information 305 for specifying the data area of the volatile memory 203 storing therein the data whose security should be ensured, when the program of the RTOS is operated are written into the flash memory FRM. The writing of the secure address information 304 and the secure data information 305 is performed before the provider PRD sells the microprocessor LSI in a manner similar to the program of the RTOS.

An arbitrary program (non-secure program) which needs not to ensure security, e.g., the non-free program and the user program U-AP are written into a program area different from the program area of the flash memory FRM, which is specified by the secure address information 304. Likewise, data (non-secure data) which needs not to ensure security, e.g., data generated when the non-free program and the user program U-AP are operated is stored in a data area different from the data area of the volatile memory 203, which is specified by the secure data information 305.

When the program area of the flash memory FRM with the non-secure program written therein is assumed to be a first program area, the program area of the flash memory FRM with the secure program written therein can be assumed to be a second program area. When it is assumed in this way, the second program area is specified by the secure address information 304. On the other hand, the program area of the flash memory FRM, which is not specified by the secure address information 304 becomes the first program area. Of course, the first program area of the flash memory FRM may be specified by non-secure address information.

Likewise, when the data area of the volatile memory 203 with the non-secure data stored therein is assumed to be a first data area, the data area of the volatile memory 203 with the secure data stored therein can be assumed to be a second data area. Even when it is assumed in this way, the second data area is specified by the secure data information 305. On the other hand, the data area of the volatile memory 203, which is not specified by the secure data information 305 becomes the first data area. Of course, the first data area of the volatile memory 203 may be specified by non-secure data information.

The secure address information 304 and the secure data information 305 are directly supplied from the flash memory FRM to the memory protection unit 204 through not the bus 205 but the signal wiring 206 shown in FIG. 2.

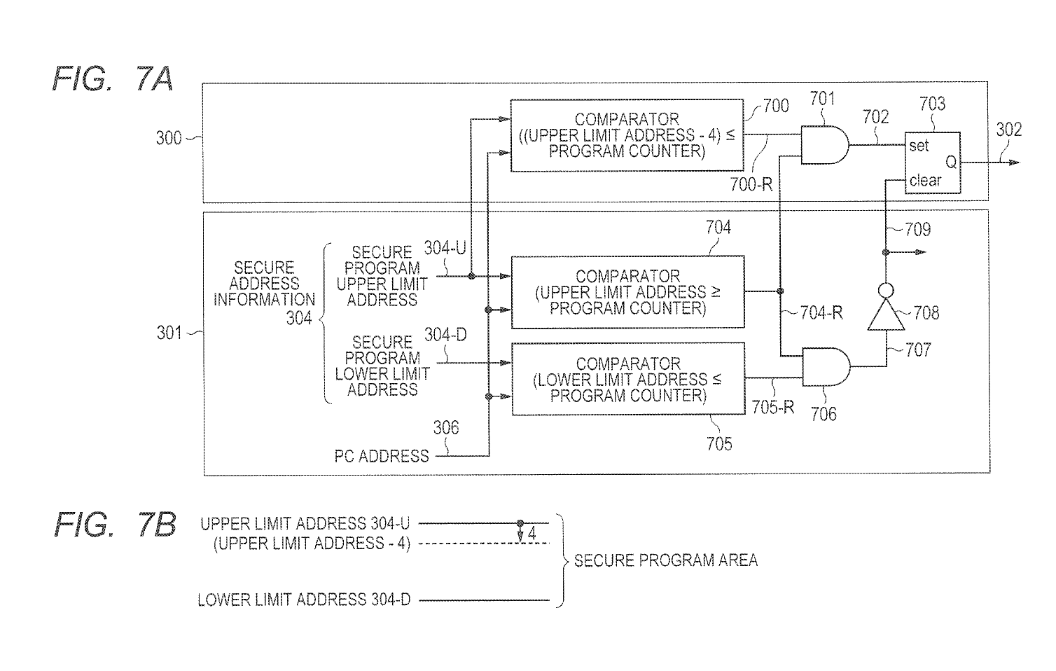

The memory protection unit 204 is equipped with a fetch start address monitoring circuit 300, a fetch address comparing circuit 301, and a memory access control circuit 303. The fetch start address monitoring circuit 300 and the fetch address comparing circuit 301 are respectively supplied with the PC address 306 from the microprocessor CPU and the secure address information 304 from the flash memory FRM. The outlines of the fetch start address monitoring circuit 300 and the fetch address comparing circuit 301 will be described here because one example therefor will be described later using FIG. 7, etc.

The fetch address comparing circuit 301 compares the PC address 306 and the secure address information 304 and outputs a selection signal indicative of whether the PC address 306 designates the inside of the second program area designated by the secure address information 304. In the present embodiment 1, the program area of the flash memory FRM is defined as a non-secure program area except for the second program area designated by the secure address information 304. Therefore, when the PC address 306 designates the inside of the secure program area (second program area), the selection signal outputted from the fetch address comparing circuit 301 can be assumed to be a secure program area signal which designates the secure program area. When the PC address 306 designates the within the non-secure program area (first program area), the selection signal can be assumed to be a non-secure program area signal which designates the non-secure program area.

When the selection signal outputted from the fetch address comparing circuit 301 indicates the secure program area, for example, the microcomputer LSI is configured such that the security is ensured, thereby making it possible to prevent the secure program from being stolen.

The secure address information 304 is considered to be set to, for example, a pre-fixed value and kept unchangeable. In this case, when the secure program stored in the flash memory FRM is changed or when the secure program is changed after the user USR has purchased the microcomputer LSI, it becomes difficult to change the secure program area. When the secure program area cannot be changed, it becomes difficult to ensure the security in cases such as where the size of the secure program is increased, etc.

For example, in order to make it possible to change the secure address information 304 after the user USR has purchased the microcomputer LSI, the secure address information 304 is considered to be stored in a volatile memory such as a register. In this case, if the user USR is not able to manipulate the microprocessor CPU in the microcomputer LSI, it is difficult for the user USR to operate the register having stored the secure address information 304 therein. As a result, the secure program area can be changed while ensuring the security.

In the present embodiment 1, however, the user USR generates, for example, the user program U-AP for manipulating the microprocessor CPU after having purchased the microcomputer LSI. That is, the user USR is capable of manipulating the microprocessor CPU. For that reason, the user USR is able to generate software (non-secure program) which operates the volatile memory such as the register having the secure address information 304 therein. Changing the secure address information 304 stored in the register makes it possible to steal the secure program.

In the present embodiment 1, the secure address information 304 and the secure data information 305 are written into the electrically rewritable flash memory FRM before the provider PRD sells the microcomputer LSI. Thus, the secure address information 304 and the secure data information 305 corresponding to the secure program can be written into the flash memory FRM. Further, the provider PRD is capable of changing the secure address information 304 and the secure data information 305 as needed even after the selling of the microcomputer LSI. The secure address information 304 and the secure data information 305 stored in the flash memory FRM are also capable of ensuring the security because they are not changed by the software (non-secure program) generated by the user USR.

Further, in the present embodiment 1, the secure address information 304 and the secure data information 305 are supplied from the flash memory FRM to the memory protection unit 204 by the signal wiring 206 different from the bus 205. Thus, even though the user USR manipulates the microprocessor CPU, it becomes possible to prevent the secure address information 304 and the secure data information 305 from being read by the user USR.

The fetch start address monitoring circuit 300 outputs a secure data access permission signal 302 in response to the secure address information 304, the PC address 306, and the selection signal from the fetch address comparing circuit 301.

In the present embodiment 1, the user program U-AP or the like is operated on the program of the RTOS. Since the user program U-AP or the like is generated by the user USR, it corresponds to the non-secure program and is written into the non-secure program area of the flash memory FRM. Since the user program U-AP is operated on the program of the RTOS, an invoking of the program of the RTOS is performed from the user program U-AP.

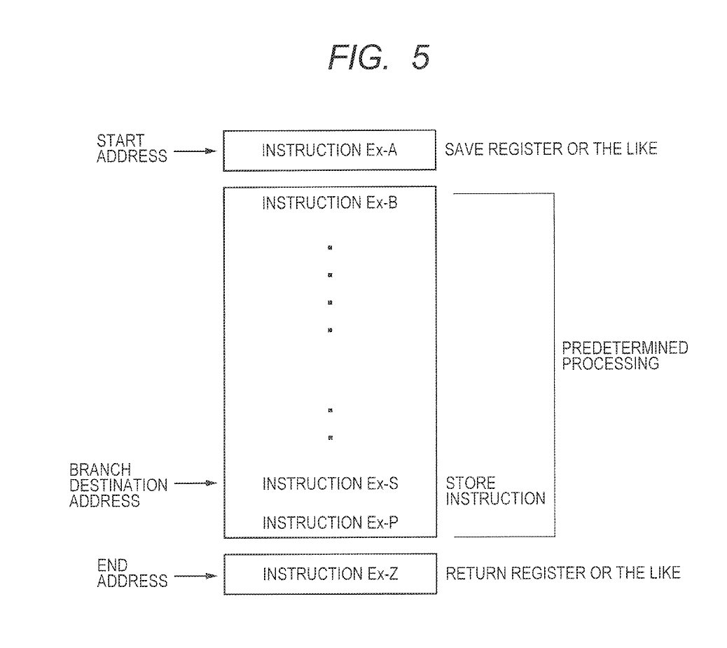

The program of the RTOS includes a plurality of subroutines for achieving functions different from each other. The user program U-AP invokes a subroutine for achieving a desired function from the subroutines. The invoking of the subroutine here is done by branching. That is, the operation of branching the user program U-AP being the non-secure program to the subroutine selected from the subroutines included in the program of the RTOS is generated. Although one example will be described later using FIG. 5, etc., a problem arises in that the configuration of monitoring whether the PC address 306 designates the inside of the secure program area is weak against an attack at the branching from the non-secure program to the secure program.

While the fetch start address monitoring circuit 300 will be described in detail later using FIG. 7 and the like, the fetch start address monitoring circuit 300 determines whether a branch destination address designates the inside of a branch allowable area (first area) which permits a fetch, when branching from the non-secure program to the secure program. If the branch destination address designates the branch allowable area, the microprocessor CPU permits access to the secure program area in the flash memory FRM, for example, based on the secure data access permission signal 302. Thus, protection against the attack at the branching from the non-secure program to the secure program is performed.

In response to the secure data information 305 from the flash memory FRM, the secure data access permission signal 302, the PC address 306, and the input/output data 307, the memory access control circuit 303 outputs an access signal 308 to the flash memory FRM and the volatile memory 203. That is, when access to the memory is allowed by the secure data access permission signal 302, the memory access control circuit 303 outputs an address signal corresponding to the PC address 306 to the memory (flash memory FRM, volatile memory 203) and permits transmission/reception of the data 307 between the address in the memory designated by the address signal and the microprocessor CPU. On the other hand, when the secure data access permission signal 302 inhibits access to the memory, the memory access control circuit 303 inhibits transmission/reception of the data 307 between the memory and the microprocessor CPU.

<Attack Example>

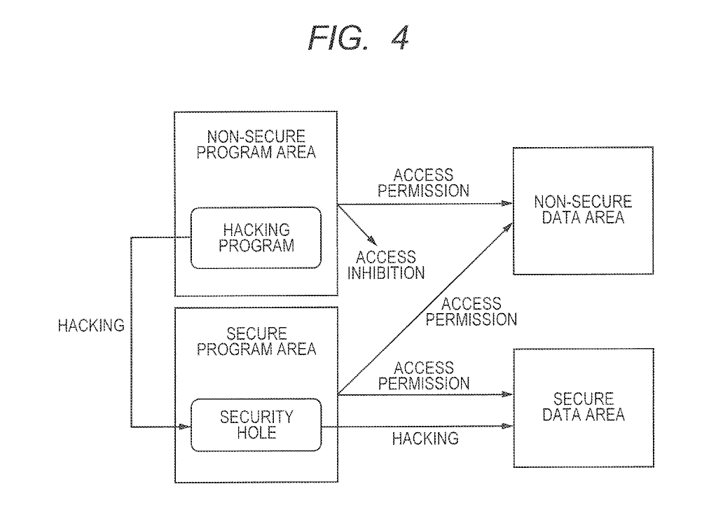

FIG. 4 is an explanatory diagram for describing where the memory is protected by using the fetch address comparing circuit 301 and the memory access control circuit 303 shown in FIG. 3. That is, FIG. 4 shows where the memory protection unit is not provided with the fetch start address monitoring circuit 300 shown in FIG. 3.

In the present embodiment 1, the non-secure program and the secure program are stored in the flash memory FRM, and the non-secure data and the secure data are stored in the volatile memory 203. The secure address information 304 which designates the secure program area with the secure program stored therein, and the secure data information 305 which designates the secure data area with the secure data stored therein are stored in the flash memory FRM.

The area (space) of the flash memory FRM is divided into the non-secure program area with the non-secure program stored therein and the secure program area with the secure program stored therein by the secure address information 304. Further, the area (space) of the volatile memory 203 is divided into the non-secure data area with the non-secure data stored therein and the secure data area with the secure data stored therein by the secure data information 305.

Both the non-secure program and the secure program are binary signals and can be assumed to be data. Therefore, in FIG. 4, the non-secure program area with the non-secure program stored therein, and the non-secure data area with the non-secure data stored therein are collectively shown as a non-secure data area. Likewise, the secure program area with the secure program stored therein, and the secure data area with the secure data stored therein are collectively shown as a secure data area in FIG. 4. In the present specification, unless otherwise specified particularly, the non-secure data means both of the non-secure program and the non-secure data, and the secure data means both of the secure program and the secure data.

In FIG. 4, a description will be made, as an example, of a case where the non-secure data area is the non-secure program area with the non-secure program stored therein, and the secure data area is the secure program area with the secure program stored therein.

When the PC address 306 designates the inside of the secure program area, i.e., when the secure program is being executed, the selection signal outputted from the fetch address comparing circuit 301 is supplied to the memory access control circuit 303 as a secure program area signal. When the PC address 306 designates the inside of the secure program area, the memory access control circuit 303 permits the microprocessor CPU to access both of the secure data area (secure program area) and the non-secure data area (non-secure program area) in response to the secure program area signal. That is, even though either of the secure data area and the non-secure data area is designated by the PC address 306, the transmission/reception of the data 307 is made possible. Thus, as shown in FIG. 4, access is permitted to both of the non-secure data area and the secure data area from the secure program arranged in the secure program area (this will be described as an access permission).

On the other hand, when the PC address 306 designates the inside of the non-secure program area being out of the secure program area, the selection signal outputted from the fetch address comparing circuit 301 becomes a non-secure program area signal which designates the non-secure program area. When the selection signal is the non-secure program area signal, the memory access control circuit 303 permits the microprocessor CPU to gain access to the non-secure data area and inhibits its access to the secure data area. That is, in this case, when the PC address 306 designates the inside of the non-secure data area, the transmission/reception of the data 307 is permitted. When the PC address 306 designates the inside of the secure data area, the transmission/reception of the data 307 is inhibited. Thus, as shown in FIG. 4, access to the non-secure data area is permitted (described as an access permission) from the non-secure program arranged in the non-secure program area, and access to the secure data area is inhibited (described as an access inhibition).

When a security hole exists in the secure program arranged in the secure program area, a hacking program is placed in the non-secure program area and executed by the microprocessor CPU, thereby making it possible to steal data (program) stored in the secure data area. That is, at the hacking program executed as the non-secure program, it is branched to an address shown as the security hole in FIG. 4. With this branch, the security program in which the security hole exists is operated. Since the hacking program is the security program, access to the secure data area is permitted so that the secure data (program) stored in the secure data area can be stored in, for example, the resistor or the like in the microprocessor CPU. This secure data (program) is returned from the secure program to the hacking program being the non-secure program in a state of being stored in the register. By reading the contents of the register when returned, the secure data (program) can be stolen. In FIG. 4, the branch generated by the attack and the access to the memory (flash memory FRM) are shown as hacking.

Although it has been described here that the secure data area is the secure program area, it becomes possible to steal the secure data stored in the volatile memory 203 similarly even in the case where the secure data area is the secure data area in the volatile memory 203.

<Example of Security Hole>

FIG. 5 is a typical diagram showing an example of the secure program in which the secure hole exists. The program of the RTOS is stored in the secure program area of the flash memory FRM. As described above, the program of the RTOS has the subroutines. FIG. 5 illustrates an example of the subroutine in which the security hole exists, out of the subroutines.

The subroutine is invoked by the branching from a main routine (or higher rank routine). That is, in the main routine, the value of the PC address 306 is defined as a value for designating an address shown as a start address in FIG. 5. Thus, a branch from the main routine to the subroutine shown in FIG. 5 is taken. If one example thereof is described, a branch instruction with the start address defined as a branch destination address is stored in the main routine. This branch instruction is executed by the microprocessor CPU to perform branching.

In the subroutine, an instruction Ex-A stored at the address specified by the start address is first executed. With the execution of the instruction Ex-A, for example, the value of the register or the like used in the processing of the main routine is saved into a stack area designated by a stack pointer (not shown). Next, the value of the PC address 306 is sequentially changed from the start address to an end address. Thus, instructions Ex-B to Ex-Pare read into the microprocessor CPU in this order and executed in a sequential order. Consequently, predetermined processing is performed and the function of the subroutine is achieved. When the value of the PC address 306 reaches a value indicative of the end address, an instruction Ex-Z is executed. With the execution of the instruction Ex-Z, the value of the register or the like stored in the stack area previously designated by the stack pointer is returned to the register in the microprocessor CPU. Thus, the value of the register in the microprocessor CPU is returned to a state prior to the branching to the subroutine.

Thus, when the branching from the main routine to the subroutine is done, predetermined processing is executed by taking branching to the prescribed start address.

Since the PC address 306 designates the inside of the secure program area when the predetermined processing is executed in FIG. 5, the fetch address comparing circuit 301 outputs a secure program area signal therefrom. Therefore, the memory access control circuit 303 permits the microprocessor CPU to access the memory (flash memory FRM). For example, when the instruction Ex-S shown in FIG. 5 is a specific store instruction, the specific store instruction is considered to be the security hole. This specific store instruction is, for example, an instruction adapted to define a value held in a specific register (hereinafter defined as R0 for convenience of description) in the microprocessor CPU as an address and store data (instruction) stored at an address in a secure data area designated by the above address in another specific register (hereinafter defined as R1 for convenience of description) in the microprocessor CPU.

In the hacking program, the address in the secure data area desired to be read is set to the specific register R0. Thereafter, the address other than the start address, at which the specific store instruction Ex-S is stored is assumed as the branch destination address, and a branch from the hacking program to the subroutine shown in FIG. 5 is taken. That is, when branching from the hacking program to the subroutine, the value of the PC address 306 is set and branched to the address (branch destination address) of the security hole (specific store instruction Ex-S), other than the start address. Thus, saving and restoring of the specific register R1 are not performed, and the secure data (instruction) stored in the specific register R1 can be read by the hacking program.

Such a security hole is considered to exist in large numbers. It is difficult to eliminate all security holes.

<Measures Against Attack>

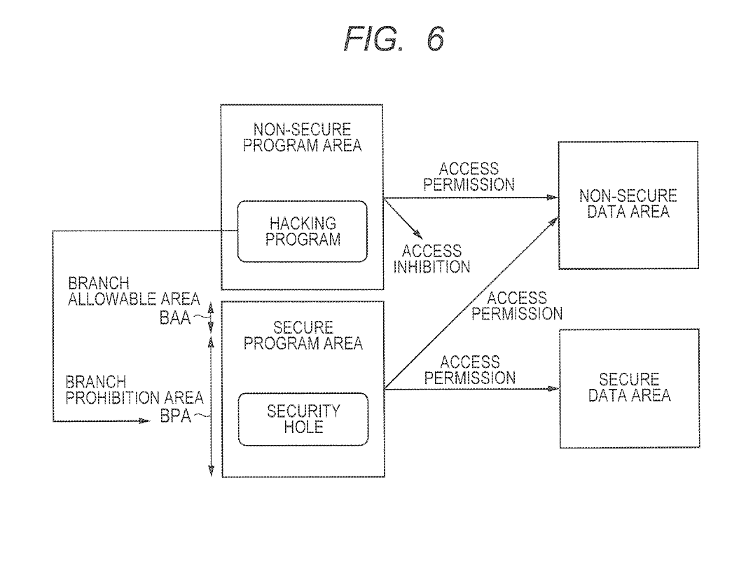

FIG. 6 is an explanatory diagram for describing where the memory is protected against the attack by using the memory protection unit 204 using the fetch address comparing circuit 301, the fetch start address monitoring circuit 300, and the memory access control circuit 303 shown in FIG. 3. FIG. 6 is similar to FIG. 4 described previously. A description will be made here principally of points of different from FIG. 4.

As described in FIG. 5, the attack is performed by making a direct branch to the security hole without branching to the start address determined by the secure program when branching from the non-secure program to the secure program stored in the secure program area. Although one example will be described later using FIG. 7, the secure program area is divided into a branch allowable area (first area) BAA and a branch prohibition area (second area different from the first area) BPA by the fetch address comparing circuit 301 and the fetch start address monitoring circuit 300. Here, the start address for the secure program is assigned to within the branch allowable area BAA, and the branch destination address which designates the security hole is assigned to within the branch prohibition area BPA. That is, if FIG. 5 is taken by way of example, the instruction Ex-A (first instruction) is arranged in the branch allowable area BAA, and other instructions Ex-B to Ex-Z (second instruction) excepting the instruction Ex-A are arranged in the branch prohibition area BPA.

When the secure program stored in the secure program area is invoked from the non-secure program stored in the non-secure program area, the fetch start address monitoring circuit 300 outputs a secure data access permission signal 302 allowing memory access where the branch destination address at its invoking designates the branch allowable area BAA. On the other hand, when the branch destination address at its invoking designates the branch prohibition area BPA, the fetch start address monitoring circuit 300 outputs a secure data access permission signal 302 inhibiting the memory access. When the secure data access permission signal 302 is indicative of permission to the memory access, the memory access control circuit 303 permits access to the memory (flash memory FRM) by the microprocessor CPU. When the secure data access permission signal 302 is indicative of inhibition of memory access, the memory access control circuit 303 inhibits access to the memory by the microprocessor CPU.

Since the branch destination address which designates the inside of the branch allowable area BAA is outputted when the non-secure program other than the hacking program invokes the secure program, the security program can be executed. On the other hand, when the hacking program invokes the address corresponding to the security hole as the branch destination address, the branch destination address which designates the branch prohibition area BPA is outputted. Therefore, in this case, the access to the memory by the microprocessor CPU is inhibited. As a result, it is possible to avoid the execution of hacking by the hacking program.

<Configurations of Fetch Start Address Monitoring Circuit and Fetch Address Comparing Circuit>

The configurations of the fetch start address monitoring circuit 300 and the fetch address comparing circuit 301 described in FIG. 3 will next be described using FIGS. 7A and 7B. FIG. 7A is a block diagram showing the configurations of the fetch start address monitoring circuit 300 and the fetch address comparing circuit 301 according to the embodiment 1. Further, FIG. 7B is an explanatory diagram showing the secure program area according to the embodiment 1.

The secure address information 304 shown in FIG. 3 includes a secure program upper limit address 304-U (upper limit address information) indicative of an upper limit address of the secure program area storing the secure program therein, and a secure program lower limit address 304-D (lower limit address information) indicative of a lower limit address of the secure program area. The area of the flash memory FRM designated by the secure program upper limit address 304-U and the secure program lower limit address 304-D assumes the secure program area (second program area) which stores the secure program therein. In other words, the secure program area of the flash memory FRM having written the secure program therein is specified by the secure program upper limit address 304-U and the secure program lower limit address 304-D.

In the present embodiment 1, the value of the upper limit address 304-U is a value larger than the value of the lower limit address 304-D. When the program is executed, the value of the PC address 306 changes from the secure program upper limit address 304-U to the secure program lower limit address 304-D. Thus, the microprocessor CPU reads an instruction out of the flash memory FRM from an instruction stored at an address designated by the upper limit address 304-U to an instruction stored at an address designated by the lower limit address 304-D and executes the read instruction. That is, the microprocessor CPU reads an instruction from a large address to a small address and executes it.

The fetch address comparing circuit 301 is equipped with comparators 704 and 705, a two-input AND circuit 706 (first logic circuit), and an inverter circuit 708 (first logic circuit).

The comparator 704 (first comparing circuit) compares the secure program upper limit address 304-U and the PC address 306. When the value of the PC address 306 is less than or equal to the value of the secure program upper limit address 304-U, the comparator 704 outputs a high-level comparison result signal 704-R. On the other hand, when the value of the PC address 306 exceeds the value of the secure program upper limit address 304-U, the comparator 704 outputs a low-level comparison result signal 704-R.

The comparator 705 (second comparing circuit) compares the secure program lower limit address 304-D and the PC address 306. When the value of the PC address 306 is greater than or equal to the value of the secure program lower limit address 304-D, the comparator 705 outputs a high-level comparison result signal 705-R. On the other hand, when the value of the PC address 306 is less than the value of the secure program lower limit address 304-D, the comparator 705 outputs a low-level comparison result signal 705-R.

The comparison result signals 704-R and 705-R respectively outputted from the comparators 704 and 705 are inputted to the two-input AND circuit 706. The logical AND of the comparison result signals 704-R and 705-R is determined by the two-input AND circuit 706. An output signal 707 of the two-input AND circuit 706 is supplied to the inverter circuit 708 where the output signal 707 is inverted in phase.

Since the comparison result signals 704-R and 705-R respectively become high in level when the value of the PC address 306 is placed between the value of the secure program upper limit address 304-U and the value of the secure program lower limit address 304-D, the output signal 707 of the two-input AND circuit 706 becomes high in level. Thus, an output signal 709 of the inverter circuit 708 becomes low in level. That is, when the address expressed by the PC address 306 designates the inside of the secure program area designated by the secure program upper limit address 304-U and the secure program lower limit address 304-D, the output signal 707 of the two-input AND circuit 706 becomes high in level, and the output signal 709 of the inverter circuit 708 becomes low in level.

On the other hand, when the value of the PC address 306 exceeds the value of the secure program upper limit address 304-U or is less than the value of the secure program lower limit address 304-D, the output signal 707 of the two-input AND circuit 706 becomes low in level, and the output signal 709 of the inverter circuit 708 becomes high in level. That is, when the address represented by the PC address 306 designates other than the secure program area, the output signal 707 becomes low in level, and the output signal 709 becomes high in level.

Therefore, each of the output signals 707 and 709 can be assumed to be a selection signal indicative of whether to select the secure program area or to select the non-secure program area. When the secure program area is selected, the output signal 707 becomes high in level. Therefore, the output signal 707 can be assumed to be a secure program area signal 707. Likewise, when the non-secure program area is selected, the output signal 709 becomes high in level. Therefore, the output signal 709 can be assumed to be a non-secure program area signal 709.

A first comparison unit can be assumed to be configured by the comparators 704 and 705, the two-input AND circuit 706, and the inverter circuit 708. In this case, the secure program area signal 707 or/and the non-secure program area signal 709 (first comparison output) formed by the first comparison unit are monitored to thereby make it possible to determine whether the PC address counter designates the secure program area or the non-secure program area.

The fetch start address monitoring circuit 300 is equipped with a comparator 700, a two-input AND circuit 701, and a flip-flop circuit 703.

The comparator 700 (third comparing circuit) is supplied with the secure program upper limit address 304-U and the PC address 306. The comparator 700 compares a value (upper limit address −4) obtained by subtracting 4 from the value of the secure program upper limit address 304-U, and the PC address 306. When the value of the PC address 306 is greater than or equal to the value (upper limit address −4) obtained by subtracting 4 from the value of the secure program upper limit address 304-U, the comparator 700 outputs a high-level comparison result signal 700-R. On the other hand, when the value of the PC address 306 is less than the value (upper limit address −4) obtained by subtracting 4 from the value of the secure program upper limit address 304-U, the comparator 700 outputs a low-level comparison result signal 700-R.

The comparison result signal 700-R and the above-described comparison result signal 704-R of the comparator 704 are supplied to the two-input AND circuit 701 (second logic circuit). An output signal of the two-input AND circuit 701 is supplied to the flip-flop circuit 703 as a secure program branch allowable area signal 702.

The flip-flop circuit 703 is equipped with a set terminal (set), a clear terminal (clear), and an output terminal (Q). The set terminal is supplied with a high level so that the output terminal becomes a high level. The high level of the output terminal is maintained (held) until the clear terminal is supplied with a high level. With the supply of the high level to the clear terminal, the output terminal changes to a low level.

The secure program branch allowable area signal 702 as the output signal of the two-input AND circuit 701 is supplied to the set terminal (set) of the flip-flop circuit 703. The above-described output signal of the inverter circuit 708, i.e., the non-secure program area signal 709 is supplied to the clear terminal (clear) of the flip-flop circuit 703. A signal outputted from the output terminal (Q) of the flip-flop circuit 703 is supplied to the memory access control circuit 303 shown in FIG. 3 as the secure data access permission signal 302.

A relationship between the secure program upper limit address 304-U, the secure program lower limit address 304-D, and the value (upper limit address −4) obtained by subtracting 4 from the value of the above-described secure program upper limit address 304-U is illustrated in FIG. 7B. In FIG. 7B, the upper limit address 304-U and the lower limit address 304-D are indicated by solid lines. The value (upper limit address −4) obtained by subtracting 4 from the value of the secure program upper limit address 304-U is indicated by a broken line.

In FIG. 7B, when the value (address) of the PC address 306 is smaller than the value (address) indicated as the upper limit address 304-U, the comparison result signal 704-R becomes high in level as described above. On the other hand, when the value of the PC address 306 is great than or equal to the value (upper limit address −4) lowered by 4 from the upper limit address 304-U, the comparator 700 outputs the high-level comparison result signal 700-R. Therefore, when the value of the PC address is less than or equal to the value of the upper limit address 304-U and greater than or equal to the value of the upper limit address −4, the two-input AND circuit 701 outputs the high-level secure program branch allowable area signal 702. The secure program branch allowable area signal 702 (second comparison output) can be assumed to be formed by a second comparison unit comprised of the comparators 700 and 704 and the two-input AND circuit 701. In this case, the comparator 704 is used commonly between the first comparison unit and the second comparison unit.

While the secure program is arranged within the secure program area, the program area designated by the value of the upper limit address 304-U and the value of (the upper limit address −4) is assumed to be the start address of the secure program (refer to FIG. 5) upon its arrangement. An instruction first executed upon branching is arranged in the start address. In the example of FIG. 5, the instruction Ex-A for saving the register or the like is arranged therein.

For example, when the value of the PC address 306 is less than the value of the lower limit address 304-D, the high-level comparison result signal 704-R is outputted from the comparator 704, and the low-level comparison result signals 700-R and 705-R are outputted from the comparators 700 and 705. As a result, the secure program branch allowable area signal 702 and the secure program area signal 707 respectively become low in level, and the non-secure program area signal 709 becomes high in level. Thus, since the high level is supplied to the clear terminal of the flip-flop circuit 703, the output terminal of the flip-flop circuit 703 becomes low in level, so that the low-level secure data access permission signal 302 is supplied to the memory access control circuit 303.

Further, when the value of the PC address 306 exceeds the value of the upper limit address 304-U, the low-level comparison result signal 704-R is outputted from the comparator 704, and the high-level comparison result signals 700-R and 705-R are outputted from the comparators 700 and 705. As a result, the secure program branch allowable area signal 702 and the secure program area signal 707 respectively become low in level, and the non-secure program area signal 709 becomes high in level. Thus, since the high level is supplied to the clear terminal of the flip-flop circuit 703, the output terminal of the flip-flop circuit 703 becomes low in level, so that the low-level secure data access permission signal 302 is supplied to the memory access control circuit 303.

When the value of the PC address 306 is less than or equal to the value of the upper limit address 304-U and greater than or equal to the value of (the upper limit address −4), the high-level comparison result signals 700-R, 704-R and 705-R are respectively outputted from the comparators 700, 704, and 705. As a result, the secure program branch allowable area signal 702 and the secure program area signal 707 respectively become high in level, and the non-secure program area signal 709 becomes low in level. Thus, since the high level is supplied to the set terminal of the flip-flop circuit 703, the output terminal of the flip-flop circuit 703 becomes high in level, so that the high-level secure data access permission signal 302 is supplied to the memory access control circuit 303.

With the secure data access permission signal 302 being set to be high in level, the memory access control circuit 303 permits the microprocessor CPU to access the memory. That is, the memory access control circuit 303 supplies the PC address 306 at this time to the memory to thereby enable transmission/reception of data between the memory and the microprocessor CPU. Therefore, the secure program branch allowable area signal 702 becomes high in level, so that the PC address 306 from the microprocessor CPU is supplied to the memory, thereby enabling transmission/reception of data between the microprocessor CPU and the memory.

On the other hand, when the value of the PC address 306 is less than the value of (the upper limit address −4) and greater than or equal to the value of the lower limit address 304-D, the comparison result signal 700-R from the comparator 700 becomes low in level, and hence the high-level comparison result signals 704-R and 705-R are respectively outputted from the comparators 704 and 705. As a result, the secure program branch allowable area signal 702 and the non-secure program area signal 709 respectively become low in level, and the secure program area signal 707 becomes high in level. Thus, since the low level is supplied to the set and clear terminals of the flip-flop circuit 703, the output terminal of the flip-flop circuit 703 maintains the previous state. If the previous state is at the high level, the high-level secure data access permission signal 302 is continuously supplied to the memory access control circuit 303. If the previous state is at the low level, the low-level secure data access permission signal 302 is continuously supplied to the memory access control circuit 303. Since the previous state is maintained (held) by the flip-flop circuit 703, the flip-flop circuit 703 can be assumed to be a holding circuit.

When the secure data access permission signal 302 is low in level, the memory access control circuit 303 inhibits access from the microprocessor CPU to the memory. That is, the memory access control circuit 303 inhibits the transfer of the PC address 306 to the memory. Thus, the transmission/reception of the data between the microprocessor CPU and the memory is inhibited.

Upon branching from the non-secure program to the secure program, the value of the PC address 306 of the microprocessor CPU is set to the start address (refer to FIG. 5) at the non-secure program. In this case, the start address is an address within the branch allowable area BAA between the upper limit address 304-U and (the upper limit address −4). When the PC address of the microprocessor CPU designates the inside of the branch allowable area, the secure program branch allowable area signal 702 becomes high in level and the secure data access permission signal 302 becomes high in level, as described above. As a result, the PC address 306 of the microprocessor CPU is transferred to the memory through the memory access control circuit 303, so that the instruction stored in the branch allowable area BAA is read and executed by the microprocessor CPU.

On the other hand, when the non-secure program is, for example, a hacking program, the value of the PC address 306 of the microprocessor CPU is set to an address other than the start address (refer to FIG. 5) at the hacking program upon branching from the hacking program to the secure program. That is, the value of the PC address 306 designates between (the upper limit address −4) and the lower limit address 304-D. In this case, the secure program branch allowable area signal 702 becomes low in level, the secure program area signal 707 becomes high in level, and the non-secure program area signal 709 becomes low in level.

The secure program branch allowable area signal 702 and the non-secure program area signal 709 become low in level, so that the voltage of the output terminal (Q) of the flip-flop circuit 703 is maintained at the previous voltage. With the branch from the non-secure program, the previous state becomes a state when the non-secure program has been executed. When the non-secure program is being executed, the non-secure program area signal 709 becomes high in level. Therefore, the output terminal (Q) of the flip-flop circuit 703 becomes low in level in the previous state. As a result, when an attempt is made to take a branch to the branch prohibition area BPA, the low-level secure data access permission signal 302 is continuously outputted. The secure data access permission signal 302 continuously becomes low in level, so that the memory access control circuit 303 inhibits access from the microprocessor CPU to the branch prohibition area in the memory.

In the present embodiment 1, the secure program area is divided into the branch allowable area BAA and the branch prohibition area BPA by the comparators 700, 704, and 705. If the branch destination address represented by the PC address 306 designates the inside of the branch allowable area BAA upon branching from the non-secure program to the secure program, the access to the memory by the microprocessor CPU is allowed. On the other hand, if the branch destination address represented by the PC address 306 designates the inside of the branch prohibition area BPA, access to the memory by the microprocessor CPU is inhibited. It is thus possible to protect the secure program and the secure data from the attack.

In the present embodiment 1, the branch allowable area BAA is a program area between the value (branch allowable area upper limit address) of the upper limit address 304-U and the value (branch allowable area lower limit address) of (the upper limit address −4). Also, the branch prohibition area BPA is a program area between the value (branch prohibition area lower limit address) of the lower limit address 304-D and the value (branch prohibition area upper limit address) of (the upper limit address −4). Further, in the present embodiment 1, although not restricted in particular, a single one-word instruction stored in the start address (refer to FIG. 5) is comprised of 4 bytes. Therefore, the branch allowable area lower limit address is defined as an address obtained by subtracting 4 from the upper limit address 304-U in such a manner that it is reduced by 4 bytes with respect to the upper limit address of the branch allowable area BAA. It is however not limited to this, and the size of the branch allowable area BAA may be determined depending on the use of the secure program or the like.

Further, although the flip-flop circuit 703 is shown with the asynchronous flip-flop circuit as an example, a synchronous flip-flop circuit may be used if there is a margin in timing for the access from the microprocessor CPU to the memory. However, when the margin is few in terms of timing, the asynchronous flip-flop circuit is preferably used.

Although there is shown here the example in which the three comparators 700, 704, and 705 are used, the present embodiment is not limited to this. For example, two comparators may respectively be used for the fetch address comparing circuit 301 and the fetch start address monitoring circuit 300. In this case, a comparator similar to the comparator 704 may be provided as a fourth comparator in the fetch start address monitoring circuit 300. The branch allowable area BAA may be provided to be arbitrarily settable by taking an upper limit address to be compared by the fourth comparator as an address different from the upper limit address to be compared by the comparator 704.

However, the number of comparators can be reduced by making the upper limit address 304-U or the lower limit address 304-D to be common as an address to be compared with the PC address 306 in the fetch address comparing circuit 301 and the fetch start address monitoring circuit 300. In this case, the branch allowable area BAA may be defined by permission address information with the upper limit address 304-U (or lower limit address 304-D) as the reference. In the present embodiment 1, on the basis of the upper limit address 304-U, the permission address information is defined as −4, and the lower limit address of the branch allowable area BAA is defined as (the upper limit address −4).

<Operation of Memory Protection Unit>

The operation of branching from the non-secure program to the secure program will next be described using FIGS. 7 to 10. A description will first be made of the case where the non-secure program is not intended for the hacking program and is normally branched to the secure program.

<<Branch from Non-Secure Program to Secure Program>>

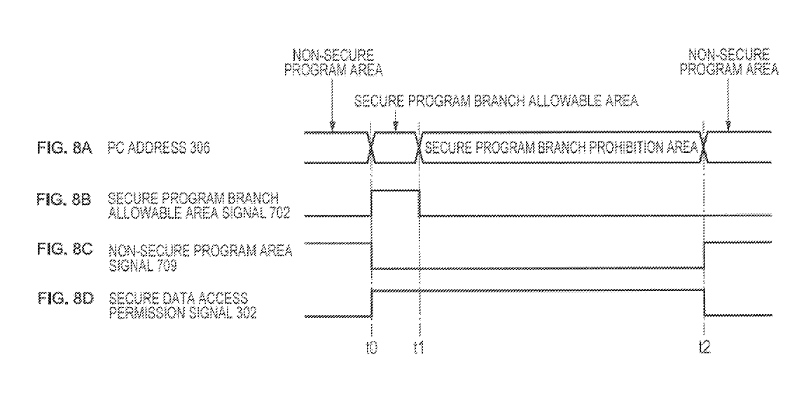

FIGS. 8A to 8D are timing diagrams showing the operation of the memory protection unit 204 according to the embodiment 1. FIG. 8 shows the case where the branch from the non-secure program to the secure program is normally done.

Till a time t0, the microprocessor CPU executes the non-secure program in the non-secure program area. That is, the PC address 306 does not designate the secure program area shown in FIG. 7B but within the non-secure program area. Therefore, the comparison result signal 704-R or 705-R from the comparator 704 or 705 (refer to FIG. 7A) becomes low in level till the time t0. Thus, the secure program area signal 707 becomes low in level, and the non-secure program area signal 709 becomes high in level. Further, since the comparison result signal 704-R or 700-R becomes low in level, the secure program branch allowable area signal 702 also becomes low in level.

Since the non-secure program area signal 709 is high in level, the clear terminal (clear) of the flip-flop circuit 703 is supplied with the high level. Since the clear terminal is supplied with the high level though the low level is supplied to the set terminal (set) of the flip-flop circuit 703, the secure data access permission signal 302 becomes low in level.

At the time t0, the microprocessor CPU executes a branch instruction in the non-secure program. The branch instruction executed at this time is a branch instruction for designating the branch to the secure program. Although not limited in particular, address information which designates the branch destination address at this time is supplied to the microprocessor CPU at the non-secure program in execution. The microprocessor CPU sets the PC address 306 according to the supplied address information. Here, the start address shown in FIG. 5 is set to the PC address 306 (refer to FIG. 8A). Since the start address corresponds to the address which designates the inside of the branch allowable area BAA, the comparison result signals 700-R, 704-R, and 705-R respectively become high in level. Consequently, the secure program area signal 707 becomes high in level, the non-secure program area signal 709 becomes low in level, and the secure program branch allowable area signal 702 becomes high in level (refer to FIGS. 8C and 8B).

Since the secure program branch allowable area signal 702 becomes high in level, the output terminal (Q) of the flip-flop circuit 703 becomes high in level. Since, at this time, the clear terminal of the flip-flop circuit 703 is supplied with the low level, the flip-flop circuit 703 outputs a high level. Thus, the secure data access permission signal 302 changes to a high level (refer to FIG. 8D). With the change of the secure data access permission signal 302 to the high level, the memory access control circuit 303 (refer to FIG. 3) permits access from the microprocessor CPU to the memory.

At a time t1, the microprocessor CPU completes the execution of the instruction (e.g., instruction Ex-A in FIG. 5) stored in the branch allowable area BAA and executes the remaining instructions of the secure program between the times t1 and t2. In order to execute the remaining instructions, the PC address 306 sequentially outputs each address which designates the inside of the branch prohibition area BPA between the times t1 and t2. If FIG. 5 is explained by way of example, the PC address 306 is sequentially updated to execute the instructions Ex-B to Ex-P relating to the predetermined processing and the instruction Ex-Z relating to the restoring of the register or the like between times t1 and t2.

These instructions are arranged in the secure program area and arranged in the branch prohibition area BPA. Therefore, at the time t1, the low-level comparison result signal 700-R is outputted from the comparator 700 between the times t1 and t2. Since, however, these instructions are arranged in the secure program area, the comparison result signals 704-R and 705-R of the comparators 704 and 705 are respectively maintained at the high level.

At the time t1, the secure program branch allowable area signal 702 changes to the low level with the comparison result signal 700-R being set low in level. Thus, the set terminal (set) of the flip-flop circuit 703 is supplied with the low level. On the other hand, since the comparison result signals 704-R and 705-R are maintained at the high level, the non-secure program area signal 709 are maintained at the low level. Therefore, the clear terminal (clear) of the flip-flop circuit 703 is continuously supplied with the low level. Since the clear terminal (clear) is low in level, the flip-flop circuit 703 maintains (holds) the state of the output terminal (Q) thereof being high in level. As a result, the secure data access permission signal 302 is also maintained at the high level between the times t1 and t2. Since the secure data access permission signal 302 is high in level, the memory access control circuit 303 continues to allow access of the microprocessor CPU to the memory even between the times t1 and t2.

When the execution of the secure program is completed at the time t2, the secure program is returned to the non-secure program. That is, the PC address 306 changes from the branch prohibition area BPA to an address which designates the inside of the non-secure program area. Since the PC address 306 changes from the secure program area to the address which designates the inside of the non-secure program area, the comparison result signal 704-R or 705-R of the comparator 704 or 705 changes to the low level at the time t2. Consequently, the non-secure program area signal 709 changes to the high level. Thus, the clear terminal (clear) of the flip-flop circuit 703 is supplied with the high level. The voltage of the output terminal (Q) of the flip-flop circuit 703 changes to the low level, and the secure data access permission signal 302 also changes to the low level. With the secure data access permission signal 302 being set low in level, the memory access control circuit 303 inhibits access to the secure program area and the secure data area of the memory by the microprocessor CPU.

When the flip-flop circuit 703 is described while paying attention to that, the output terminal (Q) thereof is maintained at the high level (predetermined state) until the address (PC address 306) from the microprocessor CPU indicates the non-secure program area, and hence the access to the memory is allowed.

Thus, it becomes possible to make the branch from the non-secure program to the secure program and execute the secure program. That is, the secure program that configures the RTOS is invoked from the non-secure program and can be made available.

<<Branch from Hacking Program to Secure Program>>

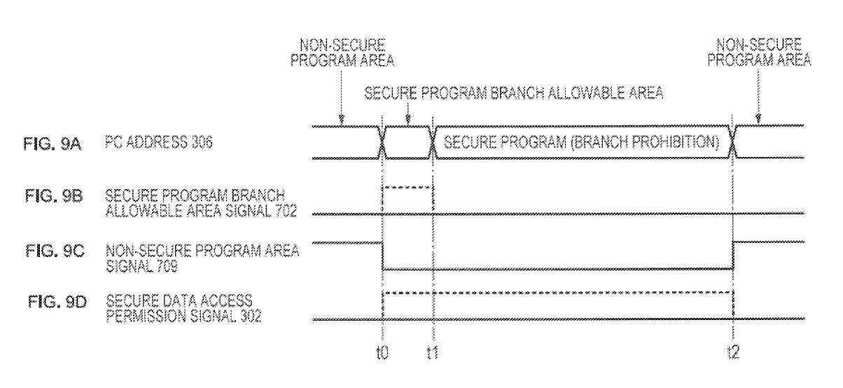

A description will next be made of the case where the branch from the hacking program to the secure program is taken. In this case, the hacking program is operated in the non-secure program area. FIGS. 9A through 9D are timing diagrams showing the operation of the memory protection unit according to the embodiment 1. FIG. 9 shows the case where the branch from the hacking program to the secure program is taken. Incidentally, in FIGS. 9B and 9D, each broken line indicates the state described in FIG. 8. That is, it indicates a state when the secure program is normally invoked from the non-secure program.

Since FIG. 9 is the same as FIG. 8 till the time t0, a detailed description will be omitted. Since, however, the non-secure program has been executed till the time t0, the non-secure program area signal 709 is held high in level. Therefore, the output terminal (Q) of the flip-flop circuit 703 is in a low-level state, and the secure data access permission signal 302 is also at the low level.

At the time t0, the microprocessor CPU executes a branch instruction in the hacking program (non-secure program). The branch instruction executed at this time is a branch instruction which designates a branch to a predetermined branch destination address of the secure program. Although not restricted in particular, at this time, address information which designates the predetermined branch destination address is supplied to the microprocessor CPU in the hacking program being in execution. The microprocessor CPU sets the PC address 306 in accordance with the given address information. In the hacking program, the branch destination address shown in FIG. 5, for example is set to the PC address 306 (refer to FIG. 9A). The branch destination address is an address different from the start address, at which a halfway instruction is stored in, for example, a series of instruction strings which configure the secure program. In the example of FIG. 5, the address at which the store instruction (Ex-S) halfway in the series of the instruction strings (instructions Ex-B through Ex-P) is stored is defined as the branch destination address.

Since the branch destination address is the address which designates the branch prohibition area BPA, the comparison result signal 700-R becomes low in level, and the comparison result signals 704-R and 705-R become high in level. Since the comparison result signals 704-R and 705-R become the high level, the secure program area signal 707 becomes high in level, and the non-secure program area signal 709 becomes low in level. On the other hand, since the comparison result signal 700-R becomes low in level, the secure program branch allowable area signal 702 also becomes low in level (refer to FIGS. 9C and 9B).

With the secure program branch allowable area signal 702 and the non-secure program area signal 709 being set low in level, the set terminal (set) and clear terminal (clear) of the flip-flop circuit 703 are respectively supplied with the low level. Therefore, the output terminal (Q) of the flip-flop circuit 703 continuously outputs the state up to the time t0. That is, the output terminal (Q) of the flip-flop circuit 703 continuously outputs the low level. Thus, as described in FIG. 8D, the secure data access permission signal 302 does not change to the high level (broken line in FIG. 9D) and maintains the low level. Since the secure data access permission signal 302 is low in level, the memory access control circuit 303 (refer to FIG. 3) inhibits access from the microprocessor CPU to the secure program area and the secure data area of the memory.

At time t1, since the access to the secure program area by the microprocessor CPU is inhibited by the memory access control circuit 303, the instruction (instruction Ex-S in FIG. 5) designated by the branch destination address in the secure program area is not read. This instruction is not executed by the microprocessor CPU. In the example of FIG. 9, the microprocessor CPU continuously outputs the PC address 306 which designates the secure program area, between the times t1 and t2. During the period in which the PC address 306 designates the secure program area, the secure program area signal 707 is continuously held at the high level, and the non-secure program area signal 709 is continuously held at the low level as shown in FIG. 9C. Therefore, in the flip-flop circuit 703 even at the period from the times t1 to t2, the output terminal (Q) thereof does not change to the high level as indicated by the broken line in FIG. 9D and is maintained at the low level. That is, the secure data access permission signal 302 is maintained at the low level.

Since the secure data access permission signal 302 is maintained at the low level, the access to the secure program area and the secure data area by the microprocessor CPU is inhibited by the memory access control circuit 303 even during the period from the time t1 to the time t2.

In the example of FIG. 9, at the time t2, the microprocessor CPU changes the address stored in the PC address 306 thereof to execute the non-secure program. When the PC address 306 is changed to the address which designates the non-secure program area, the comparison result signal 704-R or 705-R changes from the high level to the low level. Consequently, the secure program area signal 707 changes from the high level to the low level, and the non-secure program area signal 709 changes from the low level to the high level.

With the non-secure program area signal 709 being set high in level, the flip-flop circuit 703 brings the output terminal (Q) to the low level. Since the output terminal (Q) is held low in level till the time t2, it can be assumed that the flip-flop circuit 703 continuously outputs the low level from the output terminal (Q). That is, the secure data access permission signal 302 becomes low in level even after the time t2.

Since the PC address 306 designates the inside of the non-secure program area although the secure data access permission signal 302 is low in level, the memory access control circuit 303 permits access to the non-secure program area and the non-secure data area by the microprocessor CPU.

As a result, the instruction relating to the non-secure program can be executed. It is needless to say that when the instruction of the non-secure program is arranged in the hacking program after the instruction for the branch to the secure program, the instruction of the non-secure program arranged after the instruction for the branch to the secure program may be restricted so as not to be executed. For example, the secure program branch allowable area signal 702 is sampled with a timing when the non-secure program area signal 709 changes to the low level. If the sampled secure program branch allowable area signal 702 is low in level, the access to the non-secure program area and the non-secure data area by the microprocessor CPU may also be inhibited by the memory access control circuit 303 after the time t2.

Thus, since the access to the secure data (including the secure program) is inhibited by the hacking program, the secure data can be protected from the attack by the hacking program. Although the hacking program has been described by way of example, it is possible to prevent the secure data from being erroneously read due to a failure in the non-secure program.

<<Operation of Memory Protection Unit>>

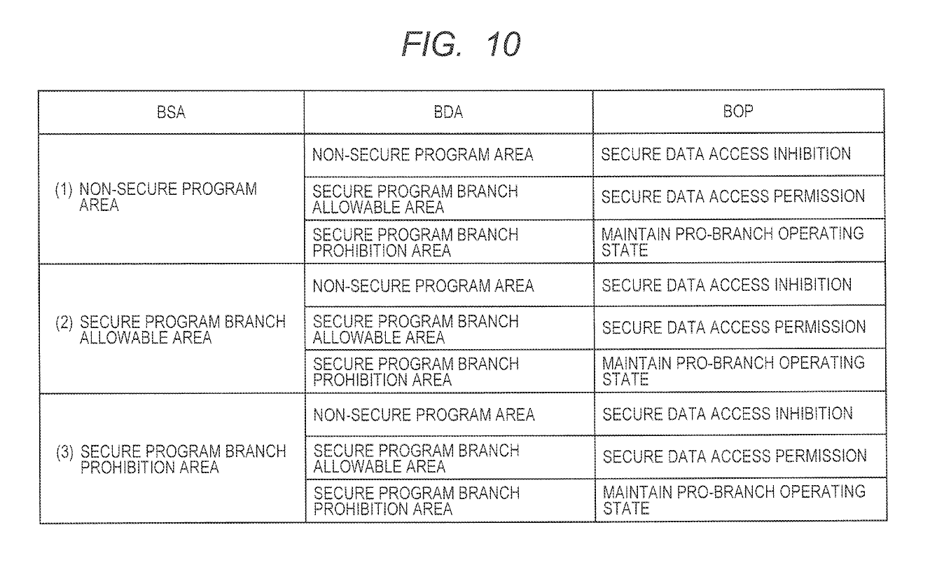

FIG. 10 is a table showing the operation of the memory protection unit 204 according to the embodiment 1. FIG. 10 shows the operation of the memory protection unit 204 at branching. In FIG. 10, BSA, BDA, and BOP indicate the columns of the table. Here, the column BSA indicates a branch source address, the column BDA indicates a branch destination address, and the column BOP indicates control at branching.

The memory protection unit 204 controls the branch source address while the branch source address being divided into three. That is, when branching is done, the memory protection unit 204 controls the branch source while the branch source being divided into “(1) non-secure program area”, “(2) secure program branch allowable area”, or “(3) secure program branch prohibition area”. In other words, when the branching is executed, the memory protection unit 204 controls the branch instruction while the branch instruction being divided into being arranged in “(1) non-secure program area”, “(2) secure program branch allowable area” or “(3) secure program branch prohibition area”. Incidentally, in FIG. 10, the secure program branch allowable area represents the branch allowable area BAA, and the secure program branch prohibition area represents the branch prohibition area BPA.

The memory protection unit 204 performs control of the “(1) non-secure program area” at the time t0 shown in FIGS. 8 and 9. Further, the memory protection unit 204 performs control of the “(2) secure program branch allowable area” and “(3) secure program branch prohibition area” during the period from the time t0 to the time t2 in FIG. 8.

The memory protection unit 204 also controls the branch destination addresses shown in the column BDA while being divided into three with respect to the branch source addresses shown in the column BSA being in the “non-secure program area”, the “secure program branch allowable area” and the “secure program branch prohibition area”. That is, when branching is done, the memory protection unit 204 controls the branch destination while the branch destination being divided into the “non-secure program area”, the “secure program branch allowable area” or the “secure program branch prohibition area”. Even in this case, the instruction for the branch destination when the branch instruction is executed can be assumed to be controlled while being divided into the instruction being arranged in the “non-secure program area”, the “secure program branch allowable area” or the “secure program branch prohibition area”.

The column BOP indicates control at the branching. Control relating to the secure data area at the branching is illustrated in FIG. 10. The secure data area shown herein means both the secure program area and the secure data area. The control relating to the secure data area exists in three ways. That is, the memory access control unit 303 is in a secure data access permission state of allowing access to the secure data area by the microprocessor CPU, a secure data access inhibition state of inhibiting access to the secure data area by the microprocessor CPU, and a maintenance state of maintaining a pro-branch operating state. Here, the maintenance state means that if the pro-branch is in the secure data access permission state, the secure data access permission state is maintained. The maintenance state means that if the pro-branch is in the secure data access inhibition state, the secure data access inhibition state is maintained.

When the branch source address corresponds to the “(1) secure program area” in the column BSA, the memory protection unit 204 determines whether the branch destination address is any of the three branch destination addresses described in the same column as the “(1) secure program area”, and executes control (control described in the column BOP) corresponding to the determined branch destination address. Likewise, when the branch source address corresponds to the “(2) secure program branch allowable area” in the column BSA, the memory protection unit 204 determines whether the branch destination address is any of the three branch destination addresses described in the same column as the “(2) secure program branch allowable area”, and executes control (control described in the column BOP) corresponding to the determined branch destination address. Further, when the branch source address corresponds to the “(3) secure program branch prohibition area” in the column BSA, the memory protection unit 204 determines whether the branch destination address is any of the three branch destination addresses described in the same column as the “(3) secure program branch prohibition area”, and executes control (control described in the column BOP) corresponding to the determined branch destination address.

The operation of the memory protection unit 204 shown in FIG. 10 will next be described using FIGS. 7 through 9.

The user program U-AP is comprised of, for example, a plurality of non-secure programs. The respective non-secure programs are arranged in the non-secure program area. When the user program U-AP indicative of the non-secure programs makes use of the secure program like the RTOS, branching is made from the non-secure program area to the secure program as described in FIGS. 8 and 9.

Since the branch from the non-secure program area is taken, the memory protection unit 204 determines that the branch source is the “(1) non-secure program area”. That is, when the program of the RTOS is invoked (branched) from the user program U-AP (at the time t0), the memory protection unit 204 determines that the branch source is the “(1) non-secure program area”.

Next, the memory access control circuit 303 in the memory protection unit 204 determines whether the non-secure program area signal 709 described in FIGS. 7, 8, and 9 is low in level. When the non-secure program area signal 709 is high in level, it is determined that the branch destination is the “non-secure program area”. The memory access control circuit 303 inhibits the microprocessor CPU from accessing the secure data area (“secure data access inhibition” in column BOP). Although not described in FIG. 10 in this case, the memory access control circuit 303 permits access to the non-secure data area by the microprocessor CPU. Thus, the branch from the prescribed non-secure program to another non-secure program is made possible in the user program. Incidentally, in FIGS. 3 and 7, a signal wiring which supplies the non-secure program area signal 709 to the memory access control circuit 303 is omitted to avoid complication of the drawings.

When the non-secure program area signal 709 is low in level, the secure data access permission signal 302 becomes high or low in level in accordance with the voltage (high level or low level) of the secure program branch allowable area signal 702 as described at the time t0 in FIGS. 8 and 9. If the non-secure program area signal 709 is low in level, and the secure data access permission signal 302 is high in level as shown in FIG. 8, the memory access control circuit 303 determines that the branch destination address (column BDA) is the “secure program branch allowable area”, and permits access to the secure data area by the microprocessor CPU (“secure data access permission”).

On the other hand, if the non-secure program area signal 709 is low in level, and the secure data access permission signal 302 is low in level as shown in FIG. 9, the memory access control circuit 303 determines that the branch destination address (column BDA) is the “secure program branch prohibition area” and becomes a state of maintaining a pro-branch operating state. As described at the time t0 in FIG. 9, the output terminal (Q) of the flip-flop circuit 703 maintains a state prior to the time t0. In this case, the previous state is a state in which access to the secure data is inhibited. Therefore, in this case, a state in which access to the secure data area by the microprocessor CPU is inhibited is maintained. In the case of FIG. 9, this state is maintained even during the period from the time t0 to the time t2.

When it is determined at the time t0 that the branch destination address is the “secure program branch allowable area”, the memory protection unit 204 executes control on the “(2) secure program branch allowable area” or the (3) secure program branch prohibition area” during the period from the time t0 to the time t2.

First, the microprocessor CPU executes the instruction arranged in the secure branch allowable area during the period from the time t0 to the time t1. When the instruction to be executed is a branch instruction at this time, the control on the “(2) secure branch allowable area” is executed. That is, if the branch destination address for the branch instruction to be executed during this period is the “non-secure program area”, the non-secure program area signal 709 becomes low in level. Thus, the memory access control circuit 303 inhibits access to the secure area by the microprocessor CPU (secure data access inhibition). In this case, since the output terminal (Q) of the flip-flop circuit 703 shown in FIG. 7 is cleared to the low level, it is required for the non-secure program to execute the branch instruction which designates the secure program branch allowable area for the purpose of utilizing the secure program again from the non-secure program.

If the branch destination address for the branch instruction executed from the time t0 to the time t1 designates the “secure program branch allowable area”, the secure program branch allowable area signal 702 becomes high in level. Thus, the output terminal (Q) of the flip-flop circuit 703 shown in FIG. 7 is set to the high level. As a result, the secure data access permission signal 302 becomes high in level, and hence the memory access control circuit 303 allows the microprocessor CPU to get access to the secure data area (secure data access permission).

If the branch destination address for the branch instruction executed from the time t0 to the time t1 designates the “secure program branch prohibition area”, the secure program branch allowable area signal 702 becomes low in level as described in FIG. 8, but the non-secure program area signal 709 is maintained at the low level. Therefore, as described in FIG. 8, the voltage of the output terminal (Q) of the flip-flop 703 is maintained at the high level. That is, the state before branching is maintained. As a result, the memory access control circuit 303 maintains the operating state before branching. In this case, since the pro-branch operating state is the state of the secure data access permission, the state of access permission to the secure data area is continued by the microprocessor CPU.

Thus, the output terminal (Q) of the flip-flop circuit 703 shown in FIG. 7 is set to the high level. As a result, the secure data access permission signal 302 becomes high in level, and hence the memory access control circuit 303 allows the microprocessor CPU to access the secure data area (secure data access permission).

When the branch instruction with the “secure program branch prohibition area” as the branch destination address is executed during the period from the time t0 to the time t1, the microprocessor CPU is operated during the period shown as from the time t1 to the time t2 in FIG. 8. In this case, the microprocessor CPU executes the secure program stored in the secure program branch prohibition area. In other words, during this period, the branch instruction to be executed by the microprocessor CPU assumes that the branch source address corresponds to the “(3) secure program branch prohibition area”.

When the branch source address assumes the “(3) secure program branch prohibition area”, i.e., during the period from the time t1 to the time t2 in FIG. 9, the microprocessor CPU executes the instruction arranged in the secure branch prohibition area. During this period, if the instruction to be executed is a branch instruction, and its branch destination address is the “non-secure program area”, the non-secure program area signal 709 becomes low in level. Thus, the memory access control circuit 303 inhibits access to the secure data area by the microprocessor CPU (secure data access inhibition). In this case, since the output terminal (Q) of the flip-flop circuit 703 shown in FIG. 7 is cleared to the low level, it is required for the non-secure program to execute the branch instruction which designates the secure program branch allowable area for the purpose of utilizing the secure program again from the non-secure program.

If the branch destination address for the branch instruction executed from the time t1 to the time t2 designates the “secure program branch allowable area”, the secure program branch allowable area signal 702 becomes high in level. Thus, the output terminal (Q) of the flip-flop circuit 703 shown in FIG. 7 is set to the high level. As a result, the secure data access permission signal 302 becomes high in level, and hence the memory access control circuit 303 allows the microprocessor CPU to access the secure data area (secure data access permission).

If the branch destination address for the branch instruction executed from the time t1 to the time t2 designates the “secure program branch prohibition area”, the secure program branch allowable area signal 702 becomes low in level as described in FIG. 8, but the non-secure program area signal 709 is maintained at the low level. Therefore, as described in FIG. 8, the voltage of the output terminal (Q) of the flip-flop 703 is maintained at the high level. That is, the state before branching is maintained. As a result, the memory access control circuit 303 maintains the operating state before branching. In this case, since the pro-branch operating state is the state of the secure data access permission, the state of access permission to the secure data is continued by the microprocessor CPU.

Thus, the output terminal (Q) of the flip-flop circuit 703 shown in FIG. 7 is set to the high level. As a result, the secure data access permission signal 302 becomes high in level, and hence the memory access control circuit 303 allows the microprocessor CPU to access the secure data area (secure data access permission).

Incidentally, in FIGS. 8 and 9, the non-secure program is executed at the time t2. The example of FIG. 8 shows the operation where the branch destination address designates the “non-secure program area” in the control of the “(3) secure program branch prohibition area”. Further, the example of FIG. 9 shows the operation where the branch destination address designates the “non-secure program area” in the control of the “(1) non-secure program area”. Even in both cases, the memory access control circuit 303 inhibits the microprocessor CPU from accessing the secure data area and permits access to the non-secure data area by the microprocessor CPU.

Although a description has been made about the example in which the non-secure program area signal 709 is supplied to the memory access control circuit 303 by the unillustrated signal wiring, the present embodiment is not limited to this. For example, the secure program area signal 707 may be supplied to the memory access control circuit 303 by the unillustrated signal wiring.

As described above, in the present embodiment 1, the access from the non-secure program to the secure data area is allowed when the branch destination address for the branch instruction in the non-secure program designates the secure program branch allowable area (branch allowable area BAA). Thus, the secure program like the RTOS can be protected from the attack by the hacking program even if the non-secure program capable of operating the microprocessor CPU is allowed to be arbitrarily generated.

Further, when the branch instruction with the secure program prohibition area as the branch destination address is executed in the secure program branch prohibition area, the state prior to the execution of the branch instruction is maintained for the permission/inhibition of access to the secure data area. Thus, even when the branch instruction with the secure program branch prohibition area as the branch destination is executed in the secure program arranged in the secure program branch prohibition area, the microprocessor CPU is capable of accessing the secure data area. As a result, even when another subroutine is invoked (branched) from a prescribed subroutine in the secure program like the RTOS, it is possible to effectively utilize the RTOS from the user program U-AP.

Incidentally, the access to the secure data area is inhibited when the branch destination address for the branch instruction designates the non-secure program area.

<Modification>

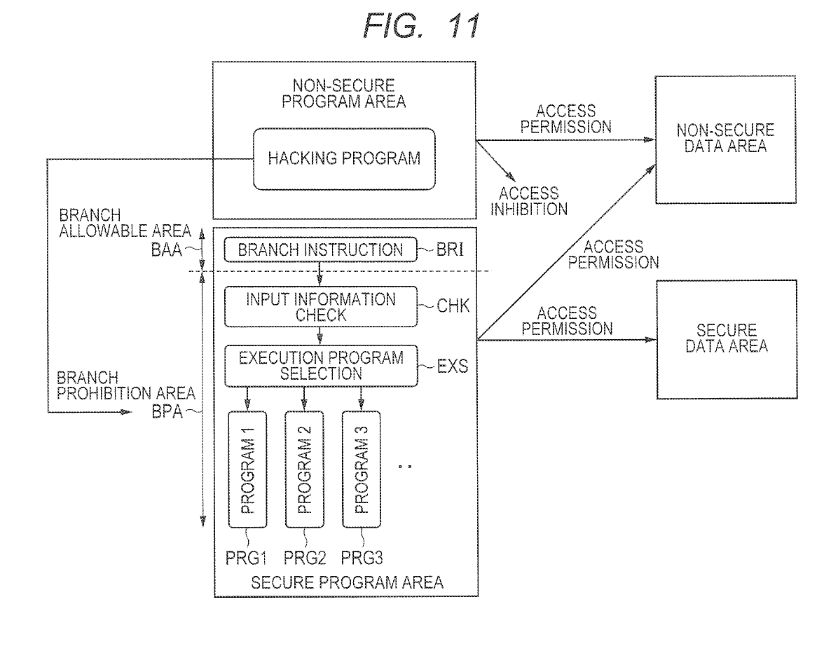

FIG. 11 is an explanatory diagram showing a modification according to the embodiment 1. Since FIG. 11 is similar to FIG. 6, points of difference from FIG. 6 will principally be described.

As with FIG. 6, the flash memory FRM is provided with a non-secure program area and a secure program area. The volatile memory 203 is provided with a non-secure data area and a secure data area. Here, a program whose security should be ensured is stored in the secure program area, and data whose security should be ensured is stored even in the secure data area. Since the non-secure program area, the non-secure data area, and the secure data area are the same as those in FIG. 6, their description will be omitted.

Even in the present modification, the secure program area is divided into a branch allowable area BAA and a branch prohibition area BPA. For example, as described in FIG. 7, the secure program area is defined within the range of the area of the flash memory FRM designated by the secure program upper limit address 304-U and the secure program lower limit address 304-D, and the area of the flash memory FRM excluding the secure program area becomes the non-secure program area. Further, the branch allowable area BAA becomes a range between the (upper limit address −4) and the upper limit address 304-U both shown in FIG. 7, and the branch prohibition area BPA becomes a range between the (upper limit address −4) and the lower limit address 304-D both shown in FIG. 7.

In the modification, a prescribed branch instruction BRI is arranged in the branch allowable area BAA. Further, a check program CHK for input information check, a selection program EXS for execution program selection, and a plurality of programs PRG1 through PRGn are stored in the branch prohibition area BPA. While the programs PRG1 through PRGn are programs which implement functions different from each other, three programs PRG1 through PRG3 are illustrated in FIG. 11 as an example.

A non-secure program arranged in the non-secure program area, which is branched from the non-secure program to a secure program arranged in the secure program area includes, for example, an instruction for storing selection information for selecting the program to be executed of the programs PRG1 through PRGn in a predetermined area of the non-secure data area, and a branch instruction with a branch destination address being designated with the branch allowable area BAA. With the execution of the non-secure program by the microprocessor CPU, the PC address 306 designates the inside of the branch allowable area BAA after the selection information which designates the program to be executed of the programs PRG1 through PRGn is stored in the predetermined area of the non-secure data area.

When an address for a branch instruction BRI arranged in the branch allowable area BAA is designated by the PC address 306, the branch instruction BRI is read and executed by the microprocessor CPU. This branch instruction BRI is an instruction to branch to the check program CHK.

Next, the check program CHK is executed by executing the branch instruction BRI. In the check program CHK, the microprocessor CPU reads the selection information from the predetermined area of the non-secure data area and checks whether the read selection information is unexpected selection information. For example, the microprocessor CPU checks for whether or not the selection information is such selection information as to designate a program beyond the programs PRG1 to PRGn, etc. When it is determined to be suitable selection information by the check based on the check program CHK, the selection program EXS is next executed.

The selection program EXS selects and executes the program designated by the selection information, of the programs PRG1 to PRGn. Thus, it is possible to select and execute a desired secure program from a plurality of programs arranged in the secure program area.

Although omitted in FIG. 11, for example, an instruction for saving the value of a register or the like is arranged in the branch allowable area BAA. Further, an instruction for returning the value of the register or the like is arranged in the branch prohibition area BPA.

For example, branch instructions respectively branched to the programs PRG1 to PRGn may also be arranged in plural in the branch allowable area BAA. In this case, however, the size of the branch allowable area BAA becomes large. That is, the area where branching is allowed becomes larger, thus resulting in an increase in the area to which the hacking program can get access. According to the present modification, it is possible to suppress the size of the branch allowable area BAA from increasing. It is possible to suppress the area accessible by the hacking program from increasing.

When the branch prohibition area BPA is accessed as a branch destination address as with FIG. 6 even in the present modification, the memory protection unit 204 is capable of inhibiting access to the secure data area and protecting the secure programs PRG1 to PRGn.

Incidentally, although a description has been made about the example in which the selection information which designates the secure program is stored in the non-secure data area, the present modification is not limited to this.

According to the embodiment 1, while achieving protection of the secure program like the RTOS, the microprocessor CPU is capable of executing the secure program and executing the user program U-AP generated by the user. That is, even though the microcomputer LSI having stored the program of the RTOS therein in advance is provided, and the user manipulates (operates) the microprocessor CPU in the microcomputer LSI to generate such a user program U-AP as to use the function of the RTOS, it is possible to protect the program of the RTOS being the secure program. As a result, even at a new semiconductor business sales model, the secure program (program of RTOS) can be prevented from being stolen, and the merits of the provider can be prevented from being damaged. Consequently, the new semiconductor business sales model allows both of the provider and the user to enjoy the merits.

It is considered that in order to protect the secure program, an exception interrupt is generated to shift to a privileged mode, thereby forming the secure program area. In this case, however, it is considered that the hacking program is expanded to the non-secure program area to give noise or the like thereto and allowed to run away, thereby enabling the shift to the privileged mode and that the protection is weak against hacking using the noise.

On the other hand, the memory protection unit 204 in the embodiment 1 monitors the PC address of the microprocessor CPU and controls access to the secure data by the microprocessor CPU. It is therefore possible to prevent the protection from becoming weak against the hacking using the noise. The hacking program is expanded to the non-secure program area, and the secure program area is divided into the branch allowable area BAA and the branch prohibition area BPA even with respect to the attack done by the branch from the hacking program to the secure program, thereby suppressing the weakness of protection thereagainst.

As a result, even when the microcomputer LSI having written the program of the RTOS therein in advance is provided, and the user having purchased the microcomputer generates such a program as to utilize the function of the RTOS, it is possible to prevent the pre-written secure program from being stolen.

### Embodiment 2

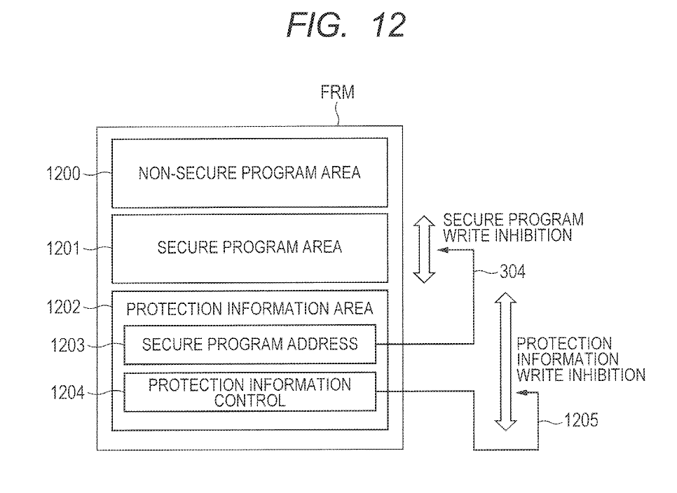

FIG. 12 is a layout diagram typically showing the layout of data stored in a flash memory FRM according to an embodiment 2.

The flash memory FRM according to the embodiment 2 is divided into a plurality of areas. Of the areas that configure the flash memory FRM, a non-secure program area, a secure program area, and a protection information area are illustrated in FIG. 12. In FIG. 12, the non-secure program area is designated at reference numeral 1200, the secure program area is designated at reference numeral 1201, and the protection information area is designated at reference numeral 1202.

In the present embodiment 2, a secure program whose security should be ensured is stored in the secure program area 1201, and a non-secure program is stored in the non-secure program area 1200. Information which protects the secure program area 1201 is stored in the protection information area 1202.

In the new semiconductor business sales model, as described in FIG. 1, the provider PRD writes the secure program like the RTOS into the flash memory FRM in the microcomputer LSI in advance before selling the microcomputer LSI. The provider PRD sets the RTOS-written area of the flash memory FRM as the secure program area 1201. Thus, the microcomputer LSI equipped with the flash memory FRM in which the secure program like the RTOS is written in the secure program area 1201 is sold from the provider PRD.

The user USR having purchased the microcomputer LSI from the provider PRD generates a user program U-AP operated using the RTOS and writes same into the non-secure program area 1200 of the flash memory FRM. When writing is made to the pre-written secure program (RTOS) upon writing the user program U-AP into the flash memory FRM, it is made possible to form a security hole in the secure program. In order to prevent it, the provider PRD provides a secure program address area 1203 in the protection information area 1202 and writes the secure address information 304, secure data information 305, etc. described above for example into the secure program address area 1203 before selling the microcomputer LSI. By the secure address information 304 (secure program upper limit address 304-U and secure program lower limit address 304-D), the secure program area is designated and the writing into the secure program area is inhibited as described in FIGS. 3 and 7.

Further, when the writing into the protection information area 1202 is made possible by the non-secure program (e.g., user program U-AP) stored in the non-secure program area 1200 after the selling, the secure program address area 1203 can be rewritten, and write inhibition of the secure program area 1201 is released to make it possible to form a security hole into the secure program. Therefore, the provider PRD provides a protection information control area 1204 in the protection information area 1202 and writes protection information 1205 which makes it unable to rewrite the protection information stored in the protection information area 1202 into the protection information control area 1204 before the selling. Consequently, the writing of the protection information into the protection information area 1202 is inhibited.

Thus, the rewriting of the secure program can be inhibited by the non-secure program stored in the non-secure program area 1200 after the selling. However, when a failure such as a bug is found in the secure program after the selling, it becomes difficult to update the secure program because the rewriting of the secure program is inhibited, thus resulting in a difficulty in taking measures against the failure. On the other hand, if the renewal of the secure program is made possible after the selling, it is feared that the security hole will be formed into the pre-written secure program.

In the present embodiment 2, it is possible to release the rewrite inhibition of the protection information area 1202 from the secure program stored in the secure program area 1201. In this case, the rewrite inhibition of the protection information area 1202 is set so as not to be unreleasable depending on the non-secure program stored in the non-secure program area 1200.

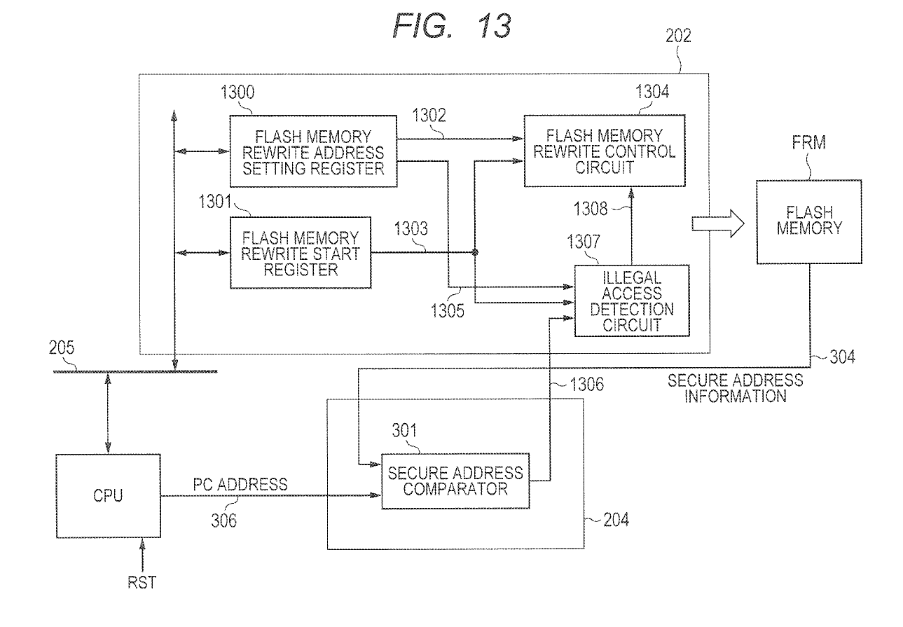

FIG. 13 is a block diagram showing the configuration of the microcomputer LSI according to the embodiment 2. Of the configuration of the microcomputer LSI shown in FIG. 2, only the microprocessor CPU, the flash memory FRM, the flash memory rewriting circuit 202, and the memory protection unit 204 are shown in the same drawing. The configuration of the flash memory rewriting circuit 202 necessary for description is shown in detail in FIG. 13.

The flash memory rewriting circuit 202 is equipped with a flash memory rewrite address setting register 1300, a flash memory rewrite start register 1301, a flash memory rewrite control circuit 1304, and an illegal access detection circuit 1307. The flash memory rewrite address setting register 1300 and the flash memory rewrite start register 1301 are coupled to the microprocessor CPU through a bus 205.

When the flash memory FRM is rewritten, an address which designates an area to be rewritten in the flash memory FRM is set to the flash memory rewrite address setting register 1300 by the microprocessor CPU through the bus 205. The flash memory rewrite address setting register 1300 supplies the set address to the flash memory rewrite control circuit 1304 as a rewrite address 1302. Further, the flash memory rewrite address setting register 1300 determines whether the set address designates the protection information area 1202 of the areas 1200 to 1202 (refer to FIG. 12) of the flash memory FRM. When the protection information area 1202 is designated, the flash memory rewrite address setting register 1300 forms a protection information selection signal 1305 and supplies same to the illegal access detection circuit 1307.

Start information indicative of the timing provided to rewrite the flash memory FRM is set from the microprocessor CPU to the flash memory rewrite start register 1301 through the bus 205. The flash memory rewrite start register 1301 forms a flash memory rewrite start signal 1303, based on the set start information and supplies same to the illegal access detection circuit 1307.

When the flash memory rewrite control circuit 1304 receives the rewrite address 1302, the flash memory rewrite start signal 1303, and an illegal access detection signal 1308 from the illegal access detection circuit 1307 therein, and the illegal access detection signal 1308 is not indicative of being illegal access, the flash memory rewrite control circuit 1304 performs rewriting on the area of the flash memory FRM designated by the rewrite address 1302. The timing provided to start rewriting at this time is defined by the flash memory rewrite start signal 1303. Incidentally, while a signal wiring for supplying data to be written into the flash memory FRM is omitted in FIG. 13 to avoid complication of the drawing, the data to be written is supplied from the microprocessor CPU to the flash memory FRM through the bus 205.

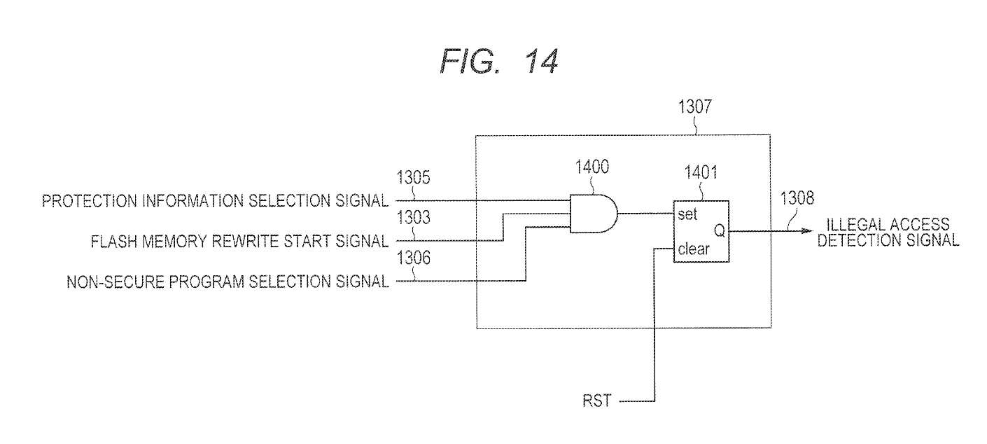

While one example of the illegal access detection circuit 1307 will be shown later using FIG. 14, the illegal access detection circuit 1307 forms the illegal access detection signal 1308 in response to a non-secure program selection signal 1306 from the memory protection unit 204, the protection information selection signal 1305 described above, and the flash memory rewrite start signal 1303 described above, and supplies same to the flash memory rewrite control circuit 1304.

The memory protection unit 204 is provided with the configuration shown in FIG. 3 and FIG. 7A. The non-secure program area signal 709 formed in the fetch address comparing circuit 301 is supplied to the illegal access detection circuit 1307 as the non-secure program selection signal 1306 described above. In the present embodiment 2, the memory protection unit 204 is used to detect whether the address (PC address 306) from the microprocessor CPU designates the secure program area or the non-secure program area.

As described in FIG. 7A, the fetch address comparing circuit 301 receives therein the secure address information 304 (secure program upper limit address 304-U, secure program lower limit address 304-D) from the flash memory FRM, and the PC address 306 from the microprocessor CPU. When the PC address 306 designates the inside of the secure program area defined by the secure address information, the secure program area signal 707 (refer to FIG. 7A) becomes high in level, and the non-secure program area signal 709 becomes low in level. On the other hand, when the PC address 306 designates the non-secure program area other than the secure program area, the secure program area signal 707 becomes low in level, and the non-secure program area signal 709 becomes high in level. Therefore, when the non-secure program arranged in the non-secure program area is being executed, the non-secure program area signal 709, i.e., the non-secure program selection signal 1306 becomes high in level.

The illegal access detection circuit 1307 determines whether the non-secure program is executed or the secure program is executed, according to whether the non-secure program selection signal 1306 is high or low in level. Also, the illegal access detection circuit 1307 determines based on the protection information selection signal 1305 whether the rewriting of the protection information area 1202 in the flash memory FRM is designated or the rewriting of the area other than the protection information area 1202 therein is designated. Further, the illegal access detection circuit 1307 determines a rewrite timing of the flash memory FRM according to the flash memory rewrite start signal 1303. In other words, the illegal access detection circuit 1307 detects whether or not illegal access is made, at a timing indicated by the flash memory rewrite start signal 1303 based on the start information from the microprocessor CPU.

When the non-secure program selection signal 1306 is indicative of the non-secure program being executed, and the protection information selection signal 1305 is indicative of the protection information area 1202, the illegal access detection circuit 1307 forms the illegal access detection signal 1308 to inhibit the rewriting to the flash memory FRM by the flash memory rewrite control circuit 1304. The illegal access detection signal 1308 is formed at the timing indicated by the flash memory rewrite start signal 1303.

Thus, it is possible to inhibit the protection information area 1202 in the flash memory FRM from being rewritten in the non-secure program. The protection information area 1202 in the flash memory FRM is allowed to be rewritten in the secure program.

FIG. 14 is a block diagram showing the configuration of the illegal access detection circuit 1307 according to the embodiment 2. In the same drawing, reference numeral 1400 is a three-input AND circuit, and reference numeral 1401 is a flip-flop circuit. The above-described protection information selection signal 1305, flash memory rewrite start signal 1303 and non-secure program selection signal 1306 are inputted to the three-input AND circuit 1400. The output of the three-input AND circuit 1400 is supplied to a set terminal (set) of the flip-flop circuit 1401. A reset signal RST of the microcomputer LSI is supplied to a clear terminal (clear) of the flip-flop circuit 1401.

Although not restricted in particular, the flip-flop circuit 1401 has a configuration similar to that of the flip-flop circuit 703 described in FIG. 7. That is, in the flip-flop circuit 1401 (holding circuit), the set terminal (set) thereof is supplied with a high level, so that an output terminal (Q) thereof becomes high in level. When the output terminal (Q) becomes high in level, the output terminal (Q) is maintained at the high level until the clear terminal (clear) is supplied with the high level even though the set terminal (set) is supplied with a low level.

A reset signal RST is supplied from the outside of the microcomputer LSI to a circuit block in the microcomputer LSI. For example, the reset signal RST is supplied even to the microprocessor CPU as shown in FIG. 13. Although not restricted in particular, in the present embodiment 2, the reset signal RST becomes high level, so that the microcomputer LSI is brought to a reset state.

When the set address designates the protection information area 1202 in the flash memory FRM, the flash memory rewrite address setting register 1300 shown in FIG. 13 forms a protection information selection signal 1305 high in level. On the other hand, when the set address designates the area (e.g., non-secure program area 1200) other than the protection information area 1202 in the flash memory FRM, the flash memory rewrite address setting register 1300 forms a protection information selection signal 1305 low in level. Further, the flash memory rewrite start register 1301 shown in FIG. 13 brings the flash memory rewrite start signal 1303 to a high level at a timing provided to rewrite the flash memory FRM. When the non-secure program is being executed, the non-secure program selection signal 1306 becomes high in level. When the secure program is being executed, the non-secure program selection signal 1306 becomes low in level.

Therefore, if the non-secure program is executed when the protection information area 1202 in the flash memory FRM is rewritten, the output signal of the three-input AND circuit 1400 becomes high in level. In other words, when an attempt is made to rewrite the protection information area 1202 in the flash memory FRM in the non-secure program, the output signal of the three-input AND circuit 1400 becomes high in level. Since the high-level output signal from the three-input AND circuit 1400 is supplied to the set terminal (set) of the flip-flop circuit 1401, the voltage of the output terminal (Q) of the flip-flop circuit 1401 becomes high in level, and the illegal access detection signal 1308 becomes high in level.

With the illegal access detection signal 1308 being held to the high level, the flash memory rewrite control circuit 1304 inhibits writing into the protection information area 1202 designated by the supplied rewrite address 1302. The flip-flop circuit 1401 maintains the output terminal (Q) at the high level until the reset signal RST becomes high in level. Therefore, the flash memory rewrite control circuit 1304 inhibits the writing into the protection information area 1202 until the microcomputer LSI is reset. Thus, even though the attack is done repeatedly by hacking means, the protection information area 1202 of the flash memory FRM can be prevented from being rewritten.

On the other hand, if the secure program is executed when the protection information area 1202 in the flash memory FRM is rewritten, the output signal of the three-input AND circuit 1400 becomes low in level. In other words, when an attempt is made to rewrite the protection information area 1202 in the flash memory FRM in the secure program, the output signal of the three-input AND circuit 1400 becomes low in level. Since the output signal of the three-input AND circuit 1400 becomes low in level, the voltage of the output terminal (Q) of the flip-flop circuit 1401 becomes low in level, and the illegal access detection signal 1308 also becomes low in level.

With the illegal access detection signal 1308 being held to the low level, the flash memory rewrite control circuit 1304 permits the writing into the protection information area 1202 designated by the supplied rewrite address 1302. That is, when access is made to the protection information area 1202 in the flash memory FRM in the secure program, it is permitted so that the protection information area 1202 can be rewritten.

According to the embodiment 2, when an attempt is made to rewrite the protection information area 1202 in the flash memory FRM in the non-secure program, the illegal access detection signal 1308 is outputted from the illegal access detection circuit 1307, and hence the flash memory rewrite control circuit 1304 inhibits writing into the protection information area 1202 in the flash memory FRM. This write inhibition is continued and cannot be released until the microcomputer LSI is reset. Thus, it is possible to prevent the protection information area 1202 of the flash memory FRM from being illegally rewritten. Since the protection information area 1202 can be prevented from being illegally rewritten, it is possible to prevent the security hole from being formed into the secure program by the non-secure program and thereby protect the secure program.

Further, when the program information area 1202 in the flash memory FRM is rewritten in the secure program, the flash memory rewrite control circuit 1304 permits writing into the protection information area 1202 of the flash memory FRM. Therefore, when a failure is found in the program (secure program) of the RTOS written in the flash memory FRM in advance, the information in the protection information area 1202 is rewritten in such a manner that the secure program area 1201 can be rewritten at the secure program. Thereafter, the RTOS (secure program) whose failure has been corrected is written into the secure program area 1201 made rewritable. After the corrected RTOS has been written, the information in the protection information area 1202 is rewritten in such a manner that the secure program area 1201 is inhibited from writing in the secure program. Thus, even when the failure is found in the secure program, it is possible to correct the secure program.

For example, the provider PRD delivers the RTOS whose failure has been corrected, and the secure program adapted to rewrite the flash memory FRM through the network NTW (refer to FIG. 1). These delivered secure programs are downloaded to the microcomputer LSI and executed. Thus, it is possible to correct the RTOS of the microcomputer LSI, which has been written in the flash memory FRM and provided in advance.

Further, the secure address information 304 described in the embodiment 1 is written into the protection information area 1202 before the provider PRD sells the microcomputer. According to the embodiment 2, however, the user USR is able to rewrite the protection information area 1202 after the user USR has purchased the microcomputer. Thus, for example, the size of the secure program area and the like can be changed later as needed.

### Embodiment 3

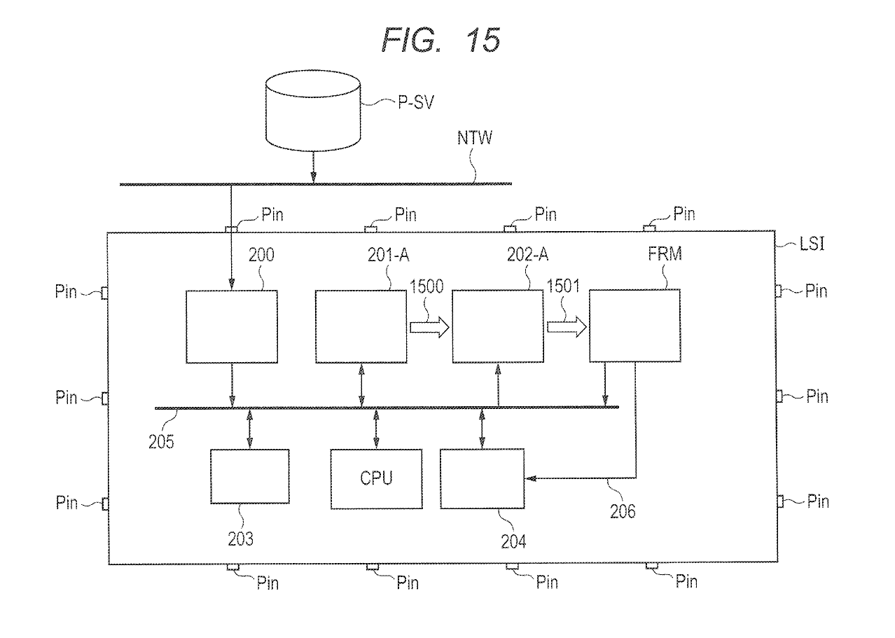

FIG. 15 is a block diagram showing the configuration of a microcomputer according to an embodiment 3. Since the microcomputer LSI shown in FIG. 15 is similar in configuration to the microcomputer shown in FIG. 2, points of difference therebetween will principally be described. Incidentally, a server P-SV and a network NTW are shown even in FIG. 15 as with FIG. 2 besides the microcomputer LSI.

In the new semiconductor business sales model, as described in FIG. 1, the provider PRD writes the secure program like the RTOS into the flash memory FRM in advance. The microcomputer LSI equipped with the flash memory FRM with the RTOS written therein, the microprocessor CPU, etc. is sold from the provider PRD. The user USR writes the user program U-AP or the like generated by the user USR into the flash memory FRM in the purchased microcomputer LSI.

In the cases such as when the user USR performs version-up of the secure program like the RTOS stored in the flash memory FRM of the purchased microcomputer LSI or corrects its inconvenience, etc., the RTOS on which version-up is performed, or the corrected RTOS is stored in the server P-SV. In this case, the RTOS subjected to the version-up or the corrected RTOS is encrypted and stored in the server P-SV. Therefore, even though the RTOS subjected to the version-up or the corrected RTOS is stolen by the third party when the user USR causes the RTOS subjected to the version-up or the corrected RTOS to pass through the network NTW to download the RTOS subjected to the version-up or the corrected RTOS, it is difficult to operate the RTOS subjected to the version-up or the corrected RTOS.

The program (RTOS subjected to the version-up or corrected RTOS) passed through the network NTW is received by a communication functional circuit 200 and transmitted via a bus 205 to its corresponding encryption/decryption functional circuit by the microprocessor CPU, where it is decrypted. The program decrypted by the encryption/decryption functional circuit and not subjected to encryption has been stored in the volatile memory 203 by the microprocessor CPU in FIG. 2.

In the new semiconductor business sales model, the user USR generates a non-secure program for operating the microprocessor CPU. That is, the user USR is able to generate a program which is intended for the non-secure program but is for arbitrarily manipulating the microprocessor CPU. Therefore, the user USR is able to generate a hacking program which operates the microprocessor CPU. Although the protection for the secure data stored in the volatile memory 203 and the flash memory FRM, etc. can be achieved by the memory protection unit 204 described in the embodiment 1, the microprocessor CPU and the volatile memory 203 are weak against hacking, and there is the risk that a security hole is found, and the microprocessor CPU and the volatile memory 203 are subjected to hacking.

In the present embodiment 3, an encryption/decryption functional circuit 201-A (decryption circuit) is coupled to a flash memory rewrite circuit 202-A by a dedicated signal wiring 1500. The flash memory rewrite circuit 202-A is coupled to the flash memory FRM by a dedicated signal wiring 1501.

The encryption/decryption functional circuit 201-A is different from the encryption/decryption functional circuit 201 and transmits a decrypted and unencrypted program to the flash memory rewrite circuit 202-A through the dedicated signal wiring 1500. The flash memory rewrite circuit 202-A is different from the flash memory rewrite circuit 202. The flash memory rewrite circuit 202-A transmits the transmitted unencrypted program to the flash memory FRM through the dedicated signal wiring 1501 and writes the program into the flash memory FRM.

Thus, the encrypted program transmitted from the communication functional circuit 200 (communication circuit) to the encryption/decryption functional circuit 201-A by the microprocessor CPU is decrypted by the encryption/decryption functional circuit 201-A. The decrypted and unencrypted program (data) is not accessed by the microprocessor CPU and supplied directly to the flash memory rewrite circuit 202-A through the signal wiring 1500. Further, the unencrypted program (data) supplied to the flash memory rewrite circuit 202-A is not accessed by the microprocessor CPU either and supplied directly to the flash memory FRM through the signal wiring 1501.

That is, the unencrypted program (data) can be written into the flash memory FRM without interposing the microprocessor CPU and the volatile memory 203.

When hacking from outside the microcomputer LSI is taken into consideration, it is difficult to arbitrarily operate the microprocessor CPU from outside the microcomputer LSI. Therefore, for example, even though the unencrypted program (data) passes through the microprocessor CPU, it is difficult to hack the program. In the new semiconductor business sales model, however, the user generates a program capable of arbitrarily manipulating the microprocessor CPU. There is therefore a risk that for example, when the unencrypted program passes through the microprocessor CPU, the unencrypted program will be stolen. In the present embodiment 3, the unencrypted program is directly supplied from the encryption/decryption functional circuit 201-A to the flash memory FRM through the flash memory rewrite circuit 202-A without passing through the microprocessor CPU and the volatile memory 203 and written into the flash memory FRM. Thus, it is possible to protect the program from hacking.

In the embodiment 3, since the downloaded unencrypted program (data) is not accessed by the microprocessor CPU even though the microprocessor CPU is arbitrarily made operable by the hacking program, it is possible to prevent the program from being stolen.

### Embodiment 4

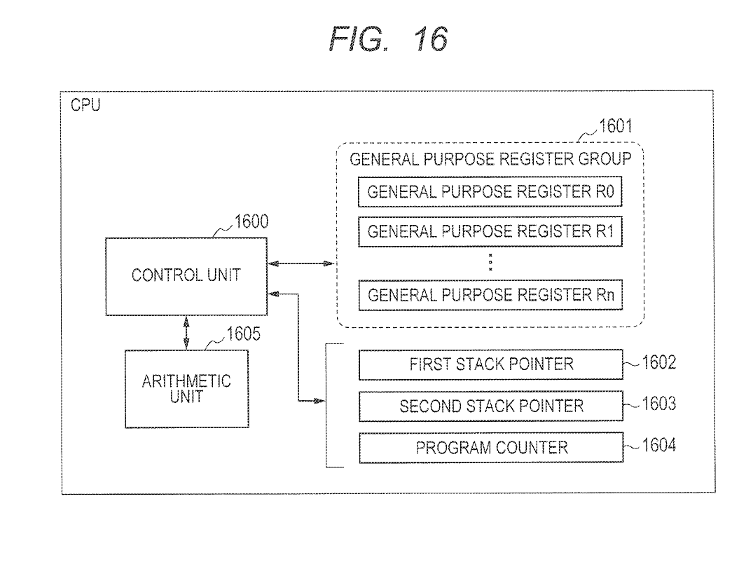

FIG. 16 is a block diagram showing the configuration of the microprocessor CPU according to an embodiment 4. FIG. 16 typically shows the configuration of the microprocessor CPU described in the embodiments 1 to 3. While the microprocessor CPU has various circuit blocks, only the circuit blocks related to the description of the embodiment 4 are shown in FIG. 16.

In the same drawing, reference numeral 1600 indicates a control unit, reference numeral 1601 indicates a general purpose register group, reference numeral 1602 indicates a first stack pointer, reference numeral 1603 indicates a second stack pointer, reference numeral 1604 indicates a program counter, and a reference numeral 1605 indicates an arithmetic unit.

The general purpose register group 1601 is equipped with a plurality of general purpose registers R0 through Rn. The general purpose registers R0 through Rn respectively store arithmetic data or/and addresses therein when the microprocessor CPU executes processing. The address stored in each of the general purpose registers R0 through Rn is used as, for example, the address for the flash memory FRM or/and the volatile memory 203 when the microprocessor CPU executes processing.

The control unit 1600 controls the general purpose registers in the general purpose register group 1601, the arithmetic unit 1605, the first stack pointer 1602, the second stack pointer 1603, and the program counter 1604 in accordance with the secure program and non-secure program stored in the flash memory FRM. With the control of these circuit blocks by the control unit 1600, the processing according to each of the secure program and the non-secure program is implemented by the microprocessor CPU.

The microprocessor CPU executes both of the secure program and the non-secure program on a time division basis. That is, both of the secure program like the RTOS and the non-secure program like the user program U-AP are executed by one microprocessor CPU on a time division basis.

The program counter 1604 forms the PC address 306 described in the embodiments 1 through 3. That is, when the microprocessor CPU executes the secure program, the program counter 1604 forms a PC address 306 which designates an instruction configuring the secure program. Likewise, when the non-secure program is executed, the program counter 1604 forms a PC address 306 which designates an instruction configuring the non-secure program. Although not restricted in particular, the first stack pointer 1602 outputs an address designating a stack area when the microprocessor CPU executes the non-secure program. Further, when the microprocessor CPU executes the secure program, the second stack pointer 1603 outputs an address which designates a stack area.

The arithmetic unit 1605 performs an arithmetic operation between the data stored in the general purpose registers R0 through Rn, for example, and stores arithmetic results in the general purpose registers as the arithmetic data or addresses.

As described above, the microprocessor CPU executes the secure program and the non-secure program on the time division basis. There is therefore a need to take measures so as to prevent the secure data generated upon execution of the secure program from being read when executing the non-secure program.

When the microprocessor CPU is operated, the first stack pointer 1602, the second stack pointer 1603, and the program counter 1604 designate the addresses for the flash memory FRM or/and the volatile memory 203 or the like, but do not store the secure data therein. Further, the memories (flash memory FRM and volatile memory 203) designated by the first stack pointer 1602, the second stack pointer 1603, and the program counter 1604 can be protected by the memory protection unit 204. As described in the embodiment 1, for example, the memory is divided into the secure program area and the non-secure program area, and the accessing of the non-secure program to the secure program area is restricted, thereby making it possible to protect the memory.

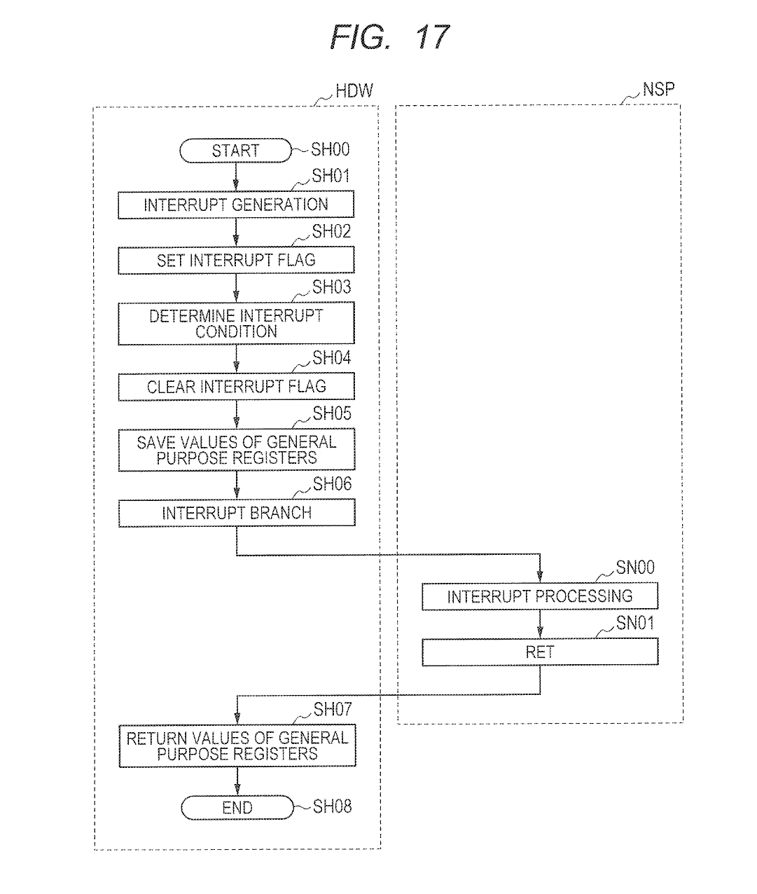

On the other hand, the general purpose registers R0 through Rn store the arithmetic data or/and addresses therein. For example, when the secure program is executed, the arithmetic data as the secure data is stored in the general purpose registers R0 through Rn. When the data stored in the general purpose registers R0 through Rn is read by the non-secure program, the secure data is stolen. An example in which the data stored in each of the general purpose registers R0 through Rn is stolen will next be described using FIG. 17.

FIG. 17 is a flowchart diagram showing the operation of the microprocessor CPU where when the secure program is being executed, a hardware interrupt is generated. In FIG. 17, HDW indicates processing executed in hardware by the microprocessor CPU, and NSP indicates processing done by the microprocessor CPU by executing a non-secure program. FIG. 17 shows an example in which when the hardware interrupt is generated, the processing is branched to interrupt processing defined by the non-secure program.

First, in Step SH00, the microprocessor CPU starts a secure program (Start). Next, in Step SH01, the hardware interrupt is assumed to have occurred (interrupt generation). An interrupt flag is set in response to the interrupt generation in Step SH02 (interrupt flag set).

Next, in Step SH03, an interrupt condition is determined (interrupt condition determination). In Step SH04, the interrupt flag is cleared (interrupt flag clear). Thereafter, in Step SH05, the values of the general purpose registers R0 through Rn are saved into, for example, the stack area defined by the second stack pointer 1603 in such a manner that after the interrupt processing, the values of the general purpose registers R0 through Rn can be returned (saving of the values of the general purpose registers). After the values of the general purpose registers R0 through Rn are saved therein, the processing is branched to the interrupt processing in Step SH06 (interrupt branch).

With the interrupt branch, the processing is next branched to the non-secure program. The microprocessor CPU executes, in Step SN00, interrupt processing in which the contents of processing are defined by the non-secure program (interrupt processing). In Step SN01, the microprocessor CPU executes a return instruction (RET).

With the execution of the return instruction (RET), the microprocessor CPU executes Step SH07. In Step SH07, the values of the general purpose registers R0 through Rn saved in Step SH05 are returned from the stack area designated by the second stack pointer 1603 to the general purpose registers R0 through Rn (returning of the values of the general purpose registers). In Step SH08, the execution of the secure program is ended (End).

Thus, when the interrupt is generated, the values of the general purpose registers R0 through Rn at the time that the secure program is executed are saved, but the interrupt processing defined by the non-secure program is performed in Step SN00 in a state in which the general purpose registers R0 through Rn hold their values. Therefore, it becomes possible to read the secure data stored in each general purpose register in the interrupt processing (Step SN00). For example, a hacking program is generated as the non-secure program and an interrupt is repeatedly generated, thereby enabling the secure data stored in the general purpose registers R0 through Rn to be stolen.

In the embodiment 4, there is provided the microcomputer LSI equipped with the microprocessor CPU capable of protecting the data stored in the general purpose registers R0 through Rn. In the embodiment 4, the protection of the data stored in the general purpose registers R0 through Rn is achieved by general purpose register clear processing by the secure program and a general purpose register clear control circuit. The general purpose register clear processing by the secure program and the general purpose register clear control circuit will next be described.

<General Purpose Register Clear by Secure Program>

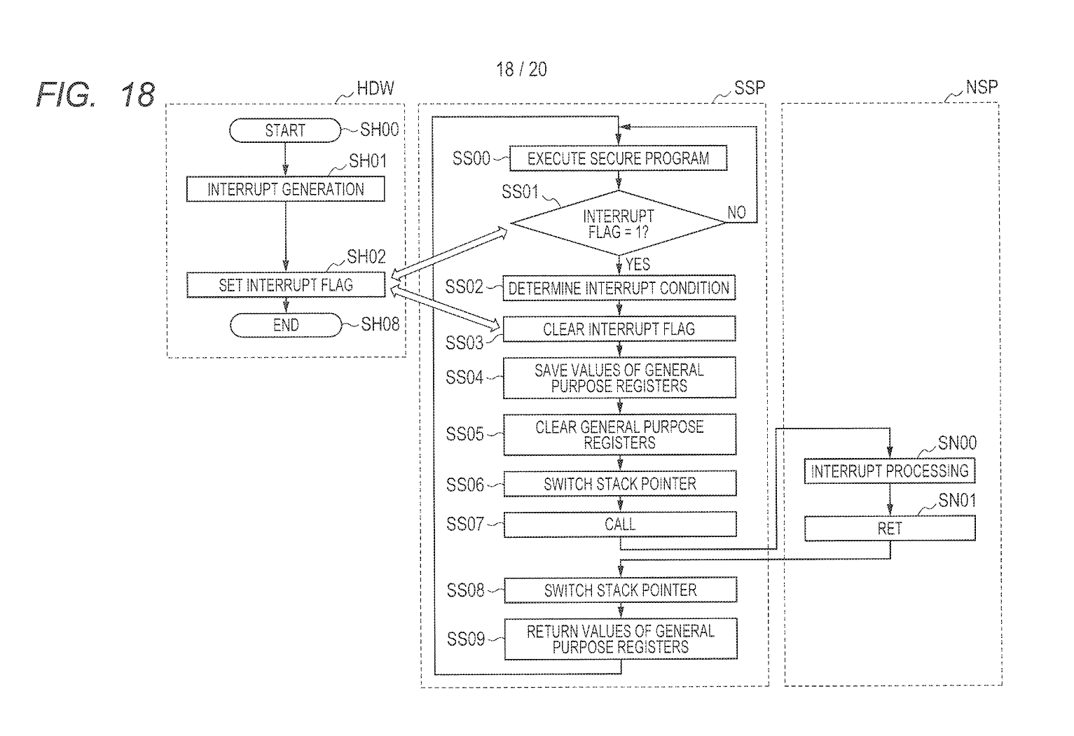

FIG. 18 is a flowchart diagram showing the operation of the microprocessor CPU according to the embodiment 4. FIG. 18 is a flowchart diagram showing the operation of the microprocessor CPU where as with FIG. 17, a hardware interrupt is generated when a secure program like an RTOS is in execution. In FIG. 18, HDW indicates processing executed in hardware of the microprocessor CPU, NSP indicates processing performed by executing a non-secure program, and SSP indicates processing done by executing the secure program. FIG. 18 also shows an example in which when the hardware interrupt is generated, the processing is branched to interrupt processing defined by the non-secure program.

The processing HDW done in hardware is achieved by Steps SH00, SH01, SH02, and SH08. Further, the processing SSP done by executing the secure program is achieved by Steps SS00 through SS09. The processing NSP done by executing the non-secure program is achieved by Steps SN00 and SN01.

In Step SH00, the secure program like the RTOS starts its operation (Start). Next, an interrupt is assumed to have been generated in Step SH01 (interrupt generation). With the generation of the interrupt, an interrupt flag is set to, for example, 1 in Step SH02 (interrupt flag set).

On the other hand, in the secure program (RTOS) having started its operation, a check (determination) for the above-described interrupt flag is performed in a predetermined cycle. That is, in the processing SSP done by executing the secure program, the microprocessor CPU executes an arbitrary secure program (secure program execution) in Step S00. After the execution of the secure program in Step S00, the microprocessor CPU determines in Step SS01 whether the interrupt flag is set to 1. If the interrupt flag is not set, the microprocessor CPU returns to Step SS00, where an arbitrary secure program is executed. On the other hand, when the interrupt flag is set to 1, Step SS02 is next executed by the microprocessor CPU. Thus, it is determined whether the interrupt flag is periodically set to 1. When the interrupt flag is not set to 1, an arbitrary secure program is repeatedly executed.

Next, the microprocessor CPU executes the secure program to thereby determine an interrupt condition in Step SS02 (interrupt condition determination) and clear the interrupt flag in Step SS03 (interrupt flag clear).

Since the interrupt flag is cleared in Step SS03, Steps SH03 (interrupt condition determination) to SH07 (returning of the value of each general purpose register) described in FIG. 17 are not performed in the processing HDW in hardware.

In Step SS04 following Step SS03, the microprocessor CPU saves the values of the general purpose registers R0 through Rn into the stack area designated by the second stack pointer 1603 (saving of the value of each general purpose register). After the saving of the values of the general purpose registers R0 through Rn, the microprocessor CPU executes Step SS05. In Step SS05, the microprocessor CPU clears the general purpose registers R0 through Rn. For example, the values of the general purpose registers R0 through Rn are cleared by writing a predetermined value into the general purpose registers R0 through Rn respectively.

After the general purpose registers R0 through Rn are cleared, the microprocessor CPU switches the stack pointer to be used from the second stack pointer 1603 to the first stack pointer 1602 in Step SS06 (switching of stack pointer). Next, in Step SS07, the microprocessor CPU executes a software interrupt instruction (CALL). At this time, a program to be invoked by the interrupt instruction is the non-secure program. The processing NSP performed by the invoked non-secure program is the same as the processing NSP described in FIG. 17. Since Steps executed by the microprocessor CPU in the processing NSP are also identical to Steps SN00 and SN01 described in FIG. 17, their description will be omitted. Incidentally, since the stack pointer is switched to the first stack pointer 1602 in Step SS06 when executing the non-secure program, the non-secure program is executed using the first stack pointer 1602.

By executing Step SN01 by the microprocessor CPU in the processing NSP, the microprocessor CPU resumes the processing in the secure program. That is, Step SS08 is next executed. In Step SS08, the stack pointer to be used is switched from the first stack pointer 1602 to the second stack pointer 1603 (switching of stack pointer). In Step SS09, the values of the general purpose registers R0 through Rn saved in Step SS04 are returned from the stack area designated by the switched second stack pointer 1603 to the general purpose registers R0 through Rn (returning of the value of each general purpose register).

After Step SS09, the microprocessor returns to Step SS00. Subsequently, Steps SS00 and SS01 are repeatedly executed until the interrupt flag is set to 1. When the interrupt flag is set to 1, Steps SS02 through SS09 and SN00 through SN01 are executed. Further, when the secure program is ended, Step SH08 is executed (End).

Thus, even when the hardware interrupt is generated when the secure program is in execution, the secure data (arithmetic data, addresses) stored in the general purpose registers R0 through Rn are cleared by the microprocessor CPU before execution of the non-secure program. It is therefore possible to prevent the secure data from being stolen.

<General Purpose Register Clear Control Circuit>

In the general purpose register clear by the secure program described in FIG. 18, the microprocessor CPU writes the predetermined value into each of the general purpose registers R0 through Rn, for example to thereby clear each of the general purpose registers R0 through Rn.

When the secure program executed by the microprocessor CPU is of the RTOS, a real-time property can be maintained if processing done for interruption is completed within a predetermined time. Therefore, if clearing of the general purpose registers by the secure program is completed within the predetermined time as the processing for the interruption, the real-time property can be maintained. Even though the response from the generation of the interrupt to execution of corresponding interrupt processing is slightly delayed behind the processing of clearing the general purpose registers, there is no problem about the real-time property.

The microcomputer LSI, for example, such an application as to control a motor is however required to execute the corresponding interrupt processing within a short period since the generation of the interrupt. That is, the shortening of a response time is required. In the present embodiment 4, the microprocessor CPU is equipped with the general purpose register clear control circuit and thus capable of achieving the shortening of the response time.

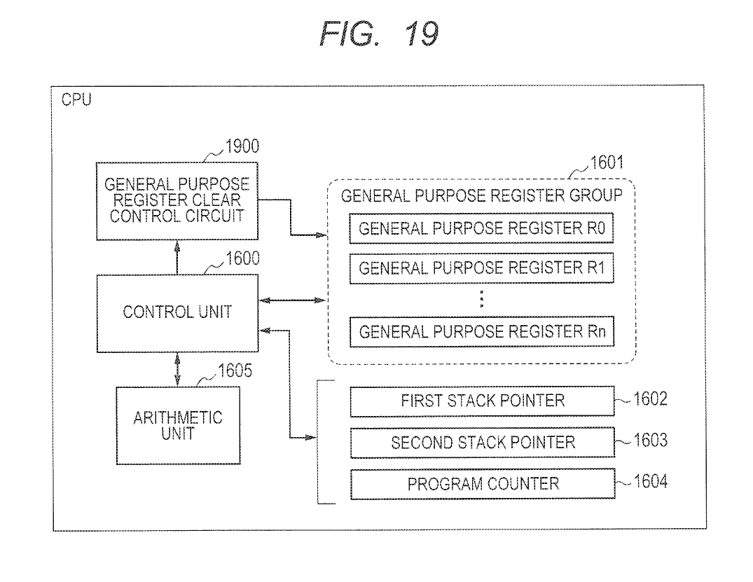

FIG. 19 is a block diagram showing the configuration of the microprocessor CPU according to the embodiment 4. Since FIG. 19 shows the microprocessor similar to the microprocessor illustrated in FIG. 16, points of difference therebetween will principally be described. In the microprocessor CPU shown in FIG. 19, a general purpose register clear control circuit 1900 is added to the microprocessor shown in FIG. 16. The general purpose register clear control circuit 1900 is coupled to the control unit 1600 and the general purpose register group 1601 and clears the general purpose registers R0 through Rn included in the general purpose register group 1601 in accordance with an instruction from the control unit 1600.

The microprocessor CPU according to the present embodiment 4 has a function of accepting a maskable interrupt (first interrupt) and a non-maskable interrupt (second interrupt different from the first interrupt). When the microprocessor CPU accepts the non-maskable interrupt, the control unit 1600 outputs an instruction for clearing the general purpose registers R0 through Rn to the general purpose register clear control circuit 1900.

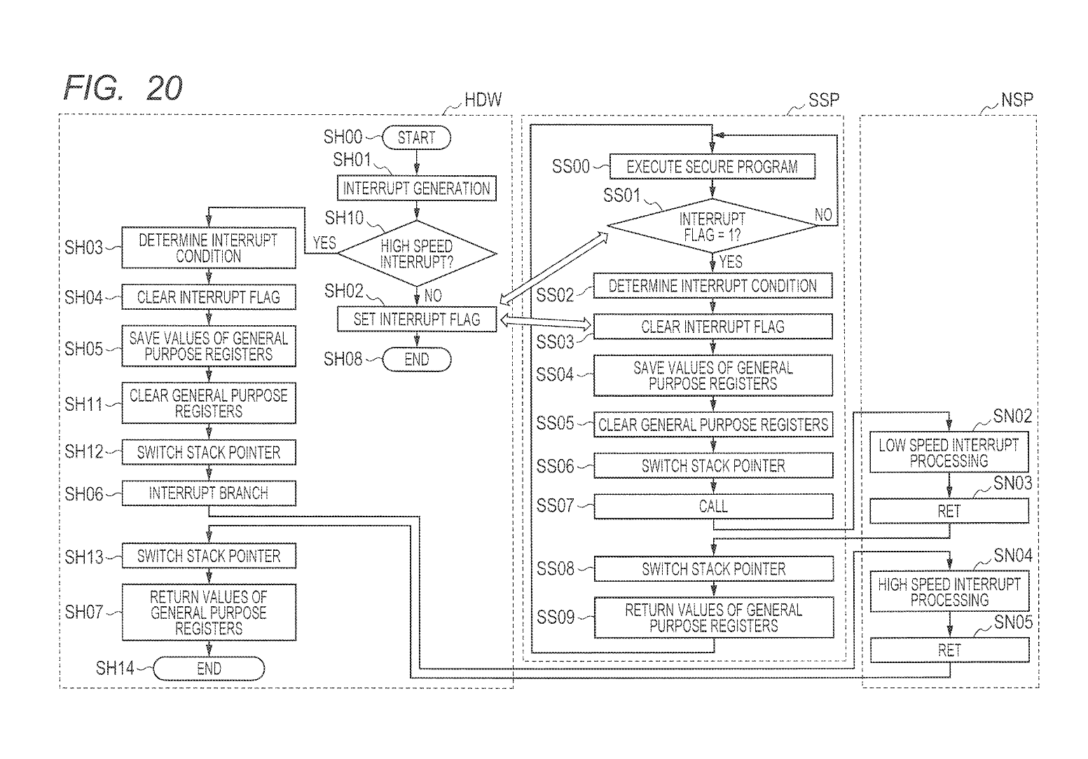

FIG. 20 is a flowchart diagram showing the operation of the microprocessor CPU shown in FIG. 19. The operation of the microprocessor CPU shown in FIG. 19 will be described using FIG. 20. Since the flowchart shown in FIG. 20 is similar to the flowchart shown in FIG. 18, different parts will principally be described herein. Even in FIG. 20, HDW indicates processing executed in hardware of the microprocessor CPU, NSP indicates processing done by executing a non-secure program, and SSP indicates processing done by executing a secure program.

The processing HDW executed in hardware is achieved by Steps SH00 through SH08 and SH10 through SH13. Further, the processing SSP done by executing the secure program is achieved by Steps SS00 through SS09. The processing NSP done by executing the non-secure program is achieved by Steps SN02 through SN05.

Since the processing SSP (Steps SS00 through SS09) done by executing the secure program is identical to the processing SSP (Steps SS00 through SS09) described in FIG. 18, their detailed description will be omitted. Step SN02 of the processing NSP done by executing the non-secure program is described as low speed interrupt processing in FIG. 20, but the same as Step SN00 described in FIG. 18. Step SN03 is the same as Step SN01 described in FIG. 18. Therefore, Steps SN02 and SN03 will not be described either.

In Step SH00, the RTOS (secure program) starts its operation (Start). Next, an interrupt is assumed to have been generated in Step SH01 (interrupt generation). Next, it is determined in Step SH10 whether the interrupt accepted in Step SH01 is a high speed interrupt (high speed interrupt?). In the present embodiment 4, the non-maskable interrupt corresponds to the high speed interrupt. That is, when the non-maskable interrupt is accepted in Step SH01, it is determined to be the high speed interrupt in Step SH10. On the other hand, when the maskable interrupt is accepted in Step SH01, it is determined not to be the high speed interrupt in Step SH10.

When the interrupt is determined not to be the high speed interrupt in Step SH10, Step SH02 is next executed. In Step SH02, the interrupt flag is set to 1. A check (determination) whether the interrupt flag is set to 1 is performed in a predetermined cycle by executing the secure program by the microprocessor CPU as described in FIG. 18. When the interrupt flag is set to 1 in Step SH02, the general purpose registers R0 through Rn are cleared in the processing SSP done by executing the secure program as described in FIG. 18. After the general purpose registers R0 through Rn are cleared, the low speed interrupt processing (Step SN02) and the RET instruction (Step SN03) are executed in the processing NSP done by executing the non-secure program.

When the interrupt is determined to be the high speed interrupt in Step SH10, an interrupt condition is next determined in Step SH03 (interrupt condition determination). In Step SH04, the interrupt flag is cleared (interrupt flag clear). After the interrupt flag is cleared, the values of the general purpose registers R0 through Rn are saved into the stack area designated by the second stack pointer 1603 (save values of general purpose registers).

After the values of the general purpose registers are saved, the control unit 1600 instructs the general purpose register clear control circuit 1900 to clear the general purpose registers R0 through Rn in Step SH11. In response to the instruction, the general purpose register clear control circuit 1900 clears the general purpose registers R0 through Rn (clear general purpose registers).

In Step SH12 following Step SH11, the stack pointer to be used is switched from the second stack pointer 1603 to the first stack pointer 1602 (switching of stack pointer). Subsequently, the processing is branched to interrupt processing (interrupt branch) in Step SH06.

With the interrupt branch, the processing is next branched to the non-secure program. The microprocessor CPU executes, in Step SN04, interrupt processing in which the contents of processing are defined by the non-secure program (high speed interrupt processing). In Step SN05, the microprocessor CPU executes a return instruction (RET).

With the execution of the return instruction (RET), the microprocessor CPU executes Step SH13. In Step SH13, the stack pointer to be used is switched from the first stack pointer 1602 to the second stack pointer 1603 (switching of stack pointer).

After the stack pointer is switched to the second stack pointer 1603, the values of the general purpose registers R0 through Rn saved in Step SH05 are returned from the stack area designated by the second stack pointer 1603 to the general purpose registers R0 through Rn (returning of the values of the general purpose registers) in Step SH07. In Step SH14, the execution of the secure program is ended (End).

In Step SS05, the microprocessor CPU clears each of the general purpose registers R0 through Rn by executing the secure program. On the other hand, in Step SH11, the general purpose register clear control circuit 1900 clears the general purpose registers R0 through Rn. The general purpose registers R0 through Rn can be cleared by the general purpose register clear control circuit 1900 at a higher speed than where, for example, the general purpose registers R0 through Rn are cleared one by one by the microprocessor CPU. Therefore, when the high speed interrupt is accepted, the high speed interrupt processing SN04 can be executed in a short response time. For that reason, the microcomputer LSI can be applied even to an application requiring that the interrupt processing is executed in the short response time. Further, since the general purpose registers R0 through Rn are cleared before execution of the non-secure program even in this case, it is possible to prevent secure data from being stolen.

Further, since the stack pointer is switched, it becomes difficult for the non-secure program to grasp the stack area in which saving is made to the general purpose registers in the secure program. Thus, it becomes possible to further prevent secure data from being stolen.

According to the present embodiment 4, the user USR having purchased the microcomputer LSI having the flash memory FRM having written the secure program like the RTOS therein is able to use the microcomputer LSI in applications each requiring a high speed interrupt such as motor control. Further, the user program generated by the user USR makes it possible to prevent the secure data from being stolen. The merit of the provider PRD that sells the microcomputer LSI can also be maintained.

### APPENDIX

A plurality of inventions have been disclosed in the present specification. Some of them are described in claims, but the inventions other than them have also been disclosed. Representative examples thereof will next be listed.

(A) A semiconductor device including a central processing unit and a nonvolatile memory storing therein a secure program and a non-secure program executed by the central processing unit,

in which the central processing unit is capable of accepting a plurality of interrupts different from each other and executes interrupt processing corresponding to an interrupt when the interrupt is generated,

in which the central processing unit includes:

a control unit operated in accordance with a program,

a plurality of registers used to hold information when the control unit is operated,

a stack pointer which designates an area for saving the values of the registers when an interrupt is generated, and

a register clear control circuit which clears the values held in the registers,

in which after the values of the registers are saved into the area designated by the stack pointer, the central processing unit clears each of the registers in response to a first interrupt of the interrupts and executes predetermined interrupt processing corresponding to the first interrupt, and

in which after the values held in the registers are saved into the area designated by the stack pointer, the central processing unit clears the registers by the register clear control circuit in response to a second interrupt different from the first interrupt, of the interrupts and executes predetermined interrupt processing corresponding to the second interrupt.

(B) The semiconductor device described in the above (A), in which the generation of the first interrupt is detected by monitoring by the secure program, and saving of the values of the registers into the area designated by the stack pointer and clearing of each of the registers are performed by execution of the secure program, and

in which in response to the generation of the second interrupt, the central processing unit saves the values of the registers into the area designated by the stack pointer and clears the registers by the register clear control circuit.

(C) The semiconductor device described in the above (B), in which the secure program is a real time operating system.

(D) A semiconductor device business sales model adapted to sell a semiconductor device incorporating therein a central processing unit which executes a program, and an electrically rewritable nonvolatile memory coupled to the central processing unit,

in which a secure program configuring the operating system is stored in the nonvolatile memory, and the semiconductor device is sold at a value including a value for the stored secure program, and

in which in the semiconductor device purchased, a program operated on the operating system is written into the electrically rewritable nonvolatile memory.

(E) The semiconductor device business sales model described in the above (D),

in which in the purchased semiconductor device, a program downloaded through a network is written into the nonvolatile memory.

(F) The semiconductor device business sales model described in the above (E),

in which the downloaded program is provided from the model which provides the semiconductor device.

(G) The semiconductor device business sales model described in the above (F),

in which the semiconductor device includes a license management unit, and license information equivalent to a value for prepaid and charged software is stored in the license management unit before selling the semiconductor device, and

in which when the downloaded program is the charged software in the purchased semiconductor device, the license management unit permits the downloaded program to be stored in the nonvolatile memory until the program reaches a value equivalent to the stored license information.

Although the invention made above by the present inventors has been described specifically on the basis of the preferred embodiments, the present invention is not limited to the embodiments referred to above. It is needless to say that various changes can be made thereto within the scope not departing from the gist thereof.

What is claimed is:

1. A semiconductor device comprising:
a memory including a first program area in which an arbitrary program is stored, and a second program area in which a program whose security is to be ensured is stored;
a central processing unit which outputs an address designating an instruction in a program; and
a memory protection unit which controls access to the memory based on the address outputted from the central processing unit,
wherein when an address outputted from the central processing unit by executing the program in the first program area designates a first area in the second program area, the memory protection unit permits access to the memory by the central processing unit, and when the address designates a second area different from the first area, the memory protection unit inhibits access to the memory by the central processing unit.

2. The semiconductor device according to claim 1,
wherein the program whose security is to be ensured includes a first instruction stored in the first area and a second instruction stored in the second area, and
wherein when the central processing unit executes the program whose security is to be ensured, the program is executed in the order of the first instruction and the second instruction.

3. The semiconductor device according to claim 2, wherein the program stored in the first program area includes an instruction with the first area as a branch destination address.

4. The semiconductor device according to claim 3,
wherein the central processing unit is equipped with a register which stores data therein when a program is executed, and
wherein the instruction stored in the first area includes an instruction for saving the data stored in the register.

5. The semiconductor device according to claim 3,
wherein a plurality of programs whose securities are respectively to be ensured are stored in the second program area, and
wherein the program selected from the programs whose securities are to be ensured is executed in accordance with selection information when the first area is designated by the central processing unit.

6. The semiconductor device according to claim 2,
wherein the memory protection unit includes:
a first comparison unit which detects whether the address outputted from the central processing unit designates the inside of the second program area;
a second comparison unit which detects whether the address outputted from the central processing unit designates the inside of the first area; and
a holding circuit which on the basis of a first comparison output from the first comparison unit and a second comparison output from the second comparison unit, assumes a predetermined state when the address outputted from the central processing unit designates the inside of the first area, and maintains the predetermined state until the address outputted from the central processing unit designates the first program area,
wherein when the holding circuit is in the predetermined state, the memory protection unit permits the central processing unit to access the memory.

7. The semiconductor device according to claim 6, comprising:
an electrically rewritable nonvolatile memory,
wherein address information designating the second program area is supplied from the electrically rewritable nonvolatile memory to the first comparison unit.

8. The semiconductor device according to claim 7,
wherein the address information designating the second program area includes upper limit address information which designates an upper limit address of the second program area, and lower limit address information which designates a lower limit address of the second program area,
wherein the first comparison unit is equipped with a first comparing circuit which compares the upper limit address information and the address from the central processing unit, a second comparing circuit which compares the lower limit address information and the address from the central processing unit, and a first logic circuit which forms the first comparison output, based on outputs of the first comparing circuit and the second comparing circuit,
wherein the second comparison unit is equipped with a third comparing circuit which compares permission address information which designates the first area with the upper limit address of the second program area as a reference, and the address from the central processing unit, and a second logic circuit which forms the second comparison output, based on the output of the first comparing circuit and an output of the third comparing circuit,
wherein the holding circuit includes a flip-flop circuit which is set by the second comparison output of the second logic circuit and cleared by the first comparison output of the first logic circuit, and
wherein each instruction stored from the upper limit address to the lower limit address is designated by the address outputted from the central processing unit to thereby execute the program arranged in the second program area.

9. The semiconductor device according to claim 8, wherein the electrically rewritable nonvolatile memory is the memory having the first program area and the second program area.

10. A semiconductor device comprising:
an electrically rewritable nonvolatile memory which stores therein a program whose security is to be ensured;
a central processing unit which outputs an address designating an instruction to be executed;
a memory protection unit which detects whether the address outputted from the central processing unit designates a secure program area in which the program whose security is to be ensured is stored within the nonvolatile memory;
a nonvolatile memory rewrite control circuit which controls rewriting of the nonvolatile memory; and
an illegal access detection circuit which is coupled to the memory protection unit and causes the nonvolatile memory rewrite control circuit to inhibit the rewriting when the memory protection unit detects that the address outputted from the central processing unit does not designate the inside of the secure program area.

11. The semiconductor device according to claim 10, comprising:
a rewrite start register to which rewrite start information is set by the central processing unit, and a rewrite address setting register to which address information to be rewritten is set by the central processing unit,
wherein when the rewrite start information is set to the rewrite start register, the address information to be rewritten is set to the rewrite address setting register, and the central processing unit outputs the address designating the inside of the secure program area, the illegal access detection circuit permits the nonvolatile memory rewrite control circuit to perform rewriting.

12. The semiconductor device according to claim 11, wherein the illegal access detection circuit is equipped with a holding circuit of which the state is set based on the rewrite start information, the address information to be rewritten, and the output from the memory protection unit, and which maintains the set state until the central processing unit is reset.

13. The semiconductor device according to claim 12,
wherein the nonvolatile memory includes a non-secure program area capable of storing an arbitrary program, and a protection information area which stores protection information therein, and
wherein upper limit address information which designates an upper limit address of the secure program area, and lower limit address information which designates a lower limit address of the secure program area are stored in the protection information area.

14. The semiconductor device according to claim 13,
wherein the memory protection unit includes:
a first comparing circuit which compares the upper limit address information and the address from the central processing unit,
a second comparing circuit which compares the lower limit address information and the address from the central processing unit, and
a logic circuit which forms an output indicative of whether the address outputted from the central processing unit designates the inside of the secure program area, based on outputs of the first comparing circuit and the second comparing circuit.

15. A semiconductor device formed in a semiconductor chip and provided with an encrypted secure program, comprising:
an electrically rewritable nonvolatile memory;
a central processing unit coupled to the nonvolatile memory and capable of executing a program written into the nonvolatile memory;
a decryption circuit which decrypts the secure program provided with being encrypted; and
a rewriting circuit which writes the secure program decrypted by the decryption circuit directly into the nonvolatile memory.

16. The semiconductor device according to claim 15,
wherein the nonvolatile memory stores a secure program and a non-secure program therein, and
wherein when the non-secure program is executed by the central processing unit, a branch from the non-secure program to the secure program is generated.

17. The semiconductor device according to claim 16, comprising:
a memory protection unit,
wherein when a branch destination address does not correspond to a predetermined area of the secure program when branching from the non-secure program to the secure program, the memory protection unit inhibits access to the nonvolatile memory by the central processing unit.

18. The semiconductor device according to claim 17, comprising:
a communication circuit which receives the encrypted secure program therein,
wherein the received encrypted secure program is transferred to the decryption circuit by the central processing unit.
